(19) United States
(12) Patent Application Publication
(10) Pub. No.: US 2026/0068904 A1
(43) Pub. Date: Mar. 12, 2026

(54) BEVERAGE TABLET AND BEVERAGE MACHINE

(71) Applicant: Keurig Green Mountain, Inc, Burlington, MA (US)

(72) Inventors: Neha Thatte Mallik, Reading, MA (US); Matthew James MAILLE, Essex Junction, VT (US); Patrick Donnelly, Ipswich, MA (US); Paul Angeloni, River Forest, IL (US); Blair Mikkelsen, Chicago, IL (US); Janelle Marie Gregory, Chicago, IL (US); Nicholas John Raleigh, Chicago, IL (US); Jonathan Meehan, Chicago, IL (US)

(73) Assignee: Keurig Green Mountain, Inc, Burlington, MA (US)

(21) Appl. No.: 19/133,677

(22) PCT Filed: Dec. 1, 2023
(86) PCT No.: PCT/US2023/082091

§ 371 Date: May 28, 2025

Related U.S. Application Data
(60) Provisional application No. 63/429,970, filed on Dec. 2, 2022.

(51) Int. Cl. A23F 5/38; A23L 2/40

(52) U.S. Cl. CPC A23F 5/385; A23L 2/40

(57) ABSTRACT

Aspects disclosed herein relate to beverage tablets and beverage machines for use in forming a beverage. Beverage ingredients may have been compacted into a tablet form to form the beverage tablets. A beverage tablet may include at least one void that may be interfaced with at least one post of a beverage machine. The at least one post of the beverage machine may be configured to interact with the beverage tablet to break the beverage tablet. The beverage machine may be configured to form a beverage from the beverage tablet.

### CROSS REFERENCE TO RELATED APPLICATION

This application claims the benefit of U.S. Provisional Application No. 63/429,970, filed Dec. 2, 2022, which is hereby incorporated by reference in its entirety.

### FIELD

Disclosed embodiments are directed to beverage tablets for use in forming beverages, as well as beverage machines for forming beverages with beverage tablets.

### BACKGROUND

Tablets of compacted beverage ingredients can be used for forming a beverage. In some arrangements, such beverage tablets are mixed directly with hot water to form a beverage. In some arrangements, water is permitted to percolate through beverage tablets to form a beverage.

### SUMMARY

According to one aspect of the invention, a beverage tablet for use in forming a beverage is provided. In some embodiments, the tablet may include a body made of one or more beverage ingredients, an outer wall, and at least one void extending into the body. The at least one void may have a shape with a finite order of rotational symmetry.

According to another aspect of the invention, a beverage tablet for use in forming a beverage is provided. In some embodiments, the tablet may include a body made of one or more beverage ingredients, an outer wall, and a plurality of voids extending into the body.

According to another aspect of the invention, a beverage machine for forming a beverage is provided. The beverage machine may include a brew chamber having a receptacle configured to receive a beverage tablet within at least one void in the tablet. The beverage machine may include at least one post configured to be received within the at least one void of the tablet. The at least one post may be configured to provide breakage of the tablet into a plurality of pieces by movement of the at least one post relative to the brew chamber.

According to another aspect of the invention, a beverage forming arrangement is provided. The arrangement may include a beverage machine. The arrangement may also include a beverage tablet for forming a beverage. The beverage tablet may comprise a body and an outer wall, where the body is made of one or more beverage ingredients, and where the beverage tablet further comprises at least one void extending into the body. The at least one void of the beverage tablet may be configured to facilitate breakage of the beverage tablet into a plurality of pieces by the beverage machine.

According to another aspect of the invention, a beverage machine for forming a beverage is provided. The beverage machine may include a chamber having a chamber receptacle configured to receive a beverage tablet, the beverage tablet having at least one void. The beverage machine may also include at least one post positioned within the chamber receptacle and configured to be received within the at least one void of the tablet. The at least one post may be configured to support the beverage tablet as a compressive force is applied to the beverage tablet by the beverage machine to provide breakage of the beverage tablet into a plurality of pieces.

According to another aspect of the invention, a method of forming a beverage from a beverage tablet is provided. The method may include receiving a beverage tablet within a chamber of a beverage machine, applying a compressive force to the beverage tablet to break the tablet into a plurality of pieces, and introducing a beverage precursor liquid to form a beverage.

### BRIEF DESCRIPTION OF DRAWINGS

Non-limiting embodiments that incorporate one or more aspects of the invention will be described by way of example with reference to the accompanying figures, which are not necessarily drawn to scale. For purposes of clarity, not every component may be labeled in every figure, nor is every component of each embodiment of the invention shown where illustration is not necessary to allow those of ordinary skill in the art to understand the invention. In the figures:

FIG. 1 is a perspective view of one embodiment of a beverage tablet;

FIG. 2 is a perspective view of another embodiment of a beverage tablet;

FIG. 3 is a perspective view of another embodiment of a beverage tablet;

FIG. 4 is a perspective view of another embodiment of a beverage tablet;

FIG. 5 is a perspective view of one embodiment of a beverage machine;

FIG. 6A is a perspective view of the beverage machine of FIG. 5 holding a beverage tablet;

FIG. 6B is a perspective view of the beverage machine of FIG. 6A, with the beverage tablet shown following a breakage event;

FIG. 7A is a perspective view of one embodiment of a beverage machine holding a beverage tablet, where the beverage tablet is shown in phantom;

FIG. 7B is a side view of the beverage machine and beverage tablet of FIG. 7A, where a brew chamber receptacle is shown in cross-section and the beverage tablet is shown in phantom;

FIG. 8 is a perspective view of another embodiment of a beverage machine holding a beverage tablet;

FIG. 9 is a schematic diagram of components of a beverage machine in an illustrative embodiment;

FIG. 10A is a cross-section view of a beverage machine and beverage tablet, where a brew chamber receptacle is shown to include a plurality of ribs;

FIG. 10B is a top view of the beverage machine and beverage tablet of FIG. 10A;

FIG. 11A is a cross-section view of a beverage machine and beverage tablet, where a chamber receptacle is shown to have a post;

FIG. 11B is top view of the beverage machine of FIG. 11A;

FIG. 12 is a top view of a beverage machine, where a chamber receptacle is shown to have a post and plurality of fins;

FIG. 13A is a perspective view of a breakage post of a beverage machine, according to one embodiment;

FIG. 13B, is a perspective view of a breakage post of a beverage machine, according to another embodiment;

FIG. 13C is a perspective view of a breakage post of a beverage machine, according to another embodiment;

FIG. 14A is a cross-section view of a portion of a beverage machine where a breakage post and a beverage tablet are shown, according to one embodiment;

FIG. 14B is a cross-section view of a portion of a beverage machine where a breakage post and a beverage tablet are shown, according to another embodiment;

FIG. 15A is a top view of a chamber of a beverage machine including a plurality of supporting ledges, according to one embodiment;

FIG. 15B is a perspective view of the chamber of FIG. 15A;

FIG. 15C is an enlarged view of a supporting ledge of FIG. 15A;

FIG. 15D is an enlarged view of a supporting ledge, according to another embodiment;

FIG. 16 is a bottom view of a beverage tablet according to one embodiment;

FIG. 17A is a schematic view of a portion of a beverage machine where a breakage post and a beverage tablet are shown, according to one embodiment;

FIG. 17B is a schematic view of a portion of a beverage machine where a breakage post and a beverage tablet are shown, according to another embodiment;

FIG. 18A is a schematic view of a portion of a beverage machine where a breakage post and a beverage tablet are shown, according to another embodiment; and

FIG. 18B is a schematic view of a portion of a beverage machine where a breakage post and a beverage tablet are shown, according to another embodiment.

### DETAILED DESCRIPTION

It should be appreciated that aspects of the invention disclosed herein are not limited in application to the details of the construction and the arrangement of components set forth in the following description or illustrated in the drawings. Further, the concepts disclosed herein may be arranged in any suitable combination, as the present disclosure is not limited in this respect. Also, the terminology used herein is for the purpose of description and should not be regarded as limiting.

It is well known to provide beverage consumables into single servings of packaging. Such consumables are commonly provided in individual packages and used with associated beverage machines to form a beverage.

These beverage machines and beverage consumables may allow a user to prepare a small quantity of a beverage, such as a single serving. Multiple users can use the same machine to prepare different beverages, such as individual servings of different beverage types or beverage flavors quickly and without wasting unconsumed beverage. Single serving or small batch beverage machines may receive individual consumables of beverage material, such as ground coffee, to be combined with liquid and brewed. These individual packages of beverage material may then be disposed after the beverage has been prepared.

The inventors have recognized and appreciated improvements in beverage material packaging, beverages machines, and methods of forming a beverage. These improvements may reduce beverage material packaging and/or waste resulting from the preparation of a beverage. According to embodiments disclosed herein, beverage material may be portioned for use within a beverage machine without separate disposable packaging for each portion.

According to aspects discussed herein, a beverage ingredient consumable may be provided in the form of a beverage tablet. In some embodiments, the beverage ingredients of the beverage tablet have been compacted to form the tablet. The beverage tablet may be able to hold its own shape, and thus may not require individual packaging to prevent dispersing of the beverage material prior to use in forming a beverage. The beverage tablet may be configured to be received within a beverage machine without packaging such that the beverage ingredients of the beverage tablet directly contacts the beverage machine (e.g. a chamber, such as a brew chamber and/or breakage chamber) during a brewing process (e.g. without requiring the beverage machine to pierce through or otherwise open packaging to access the beverage ingredients).

In some embodiments, a package-less beverage consumable (e.g., a beverage tablet) may include a shell, such as a coating, disposed along the outer surface at the periphery of the consumable. In some embodiments, the shell may bind the beverage ingredients within the interior of the consumable. The beverage ingredients within the consumable may be loose, such as loose ground coffee, or compacted. The shell may be a food grade binder, an alginate, edible, soluble, or any other suitable material. In some embodiments, the shell may serve as a barrier to reduce infiltration of oxygen and/or moisture such as to maintain freshness of the beverage ingredients. Material of the package-less beverage consumable, including a shell of the consumable if one is present, may directly contact some portion of the beverage machine, such as the brew chamber, before brewing the beverage, without intervening packaging in-between.

A package-less beverage consumable (e.g., a beverage tablet) may be configured to break into pieces during brewing or it may be configured to remain intact during brewing. The package-less beverage consumable may be configured to at least partially or completely dissolve. In some embodiments, the package-less beverage consumable may contain roasted coffee grounds (e.g. that remain behind after forming a beverage), soluble coffee, soluble materials, binders or other materials, and any combination of the above. The package-less beverage consumable may be any suitable shape, such as a cylinder, a sphere, an ellipsoid, an elliptical prism, a teardrop shape, a frustrum of a cone, a cone or other shape.

A beverage tablet may be used to form a beverage such as tea, coffee, espresso, cocoa or other beverages prepared from a powder, dry concentrate or dry beverage material such as suitably prepared coffee beans, tea leaves etc. The beverage machine may form such beverages using a base liquid, such as water, that may be combined with the beverage material under suitable conditions to form the beverage.

In some embodiments, a beverage tablet may have a body and an outer wall, where the body and/or the outer wall are made of one or more beverage ingredients. Examples of beverage ingredients include, but are not limited to: coffee (e.g., coffee grounds, soluble coffee), tea (e.g. tea leaves, dry herbal tea), powdered beverage concentrate, dried fruit extract or powder, powdered or liquid concentrated bouillon or other soup, powdered or liquid medicinal materials (e.g. nutraceuticals), powdered milk or other creamers, sweeteners, thickeners, flavorings, binding agents, coating agents, cellulose, chaff, filter aids, extracts, plant husks, plant fibers, bagasse, additives, or any other type of food. Examples of filter aids include, but are not limited to, perlite, diatomaceous earth, diatomite, chaff, and cellulose. Examples of binding agents include, but are not limited to, cellulose, cellulose derivatives, gelatin, cream, honey, starch, sucrose, mannitol, liquid glucose, and zein.

The inventors have recognized that, in some embodiments, providing breakage of a beverage tablet into a plurality of pieces may be useful in yielding efficient extraction, brewing, and dispensing of the beverage product. The inventors have also recognized that the existence of at least one void in the beverage tablet may be useful in providing an engagement point for interfacing with a beverage machine to assist in the breakage of the tablet.

In some embodiments, compressing the coffee ingredients into a compacted tablet form may serve to disrupt cellular matrix post-compaction. The inventors have found that, in some embodiments, disruption of cellular matrix may help to increase extraction yield.

In view of the above, in some embodiments, the inventors have found that it may be beneficial to provide breakage of a beverage tablet into a plurality of pieces to allow for increased water diffusion through the beverage material of the tablet. In some embodiments, a beverage tablet may be broken into 4 pieces, 8 pieces, 12 pieces, or 24 pieces. While these specified amounts of tablet pieces are disclosed, the beverage tablet may be broken into any suitable number of pieces to provide different extraction yields of the beverage product as the disclosure is not limited in this regard.

The inventors have also appreciated that extraction yields can be varied to provide different beverage experiences to the end user. For example, a desired “strength” of coffee may be achieved by breaking the tablet into more or less pieces during a beverage formation process. In some embodiments, a beverage tablet may be broken into a specified number of pieces to provide a beverage product with a set of desired sensory attributes such as espresso, drip coffee, lattes, cappuccinos, or other suitable beverage types. Such beverage tablets may comprise a single ingredient or a plurality of ingredients to provide varying beverage results following forming of the beverage.

The inventors have also found that providing breakage of a beverage tablet into a plurality of pieces may be beneficial to expedite the beverage forming process so that a beverage may be formed in a decreased amount of time. In some embodiments, a beverage may be formed in 5 minutes or less, 4 minutes or less, 3 minutes or less, 2 minutes or less, 90 seconds or less, 60 seconds or less, or any other suitable beverage forming time.

According to one aspect of the invention, the inventors have recognized that providing a beverage tablet with at least one void having a finite order of rotational symmetry may be beneficial to provide a point of engagement for use in breakage of the tablet. For example, the void may be non-circular.

In some embodiments, at least one void in a beverage tablet can be configured to be interfaced with a beverage machine to provide breakage of the tablet. For example, the beverage machine may have one or more posts sized to be received in the void(s) of the beverage tablet. In some embodiments, the tablet may have only one void. The void may be of a shape having a finite order of rotational symmetry (e.g., non-circular), which can be beneficial to provide traction between the post of the beverage machine and the void of the tablet.

In some embodiments, void shapes may include, but are not limited to: squares, rectangles, ovals, triangles, trapezoids, rhombuses, crescents, ellipses, pentagons, hexagons, heptagons, octagons, regular polygons, irregular polygons, serpentine shapes, or any other suitable shape having a finite order of rotational symmetry. In some embodiments, the void may be of a concave or convex shape as the disclosure is not limited in this regard. In some embodiments, the post may be actuated as it is interfaced with the void having a finite order of rotational symmetry, resulting in breakage of the tablet. In some embodiments, the at least one void may have a shape with rotational symmetry of order one, two, three, four, five, six, seven, eight, nine, ten, or any other suitable number. As an example, a shape having a rotational symmetry of order two means that the shape looks like its original orientation twice after a full 360 degree rotation. A shape having a rotational symmetry of order three means that the shape looks like its original orientation three times after a full 360 degree rotation. A shape having a rotational symmetry of order one means that the shape looks like its original orientation only once after a full 360 degree rotation.

In some embodiments where only a single void is used, providing the single void with a shape that is of a non-finite order of rotational symmetry (e.g. a non-circular shape) may allow for a post to avoid spinning freely within the void when the post is rotated to break the tablet. However, it should be appreciated that the voids of the tablet need not be non-circular in all embodiments.

In some embodiments, the outer wall of the tablet may have a shape that has a finite order of rotational symmetry (e.g., non-circular). In some embodiments, outer wall shapes may include, but are not limited to: squares, rectangles, ovals, triangles, trapezoids, rhombuses, crescents, ellipses, pentagons, hexagons, heptagons, octagons, regular polygons, irregular polygons, serpentine shapes, or any other suitable shape having a finite order of rotational symmetry. In other embodiments, however, the outer wall of the tablet may have a circular shape.

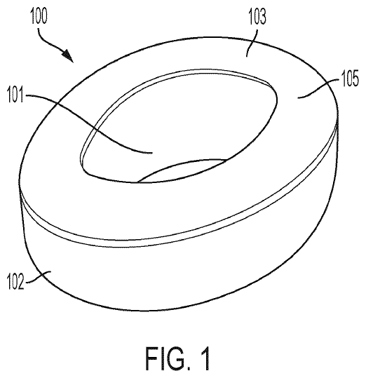

The illustrative embodiment of FIG. 1 shows one embodiment of a beverage tablet 100 in which its beverage ingredients 105 have been compacted into a tablet form. The tablet 100 has a body 103 and an outer wall 102. The body 103 and/or the outer wall 102 may be made of beverage ingredients. The tablet 100 also includes a void 101. As shown in FIG. 1, the void may be of a symmetric shape, such as an oval.

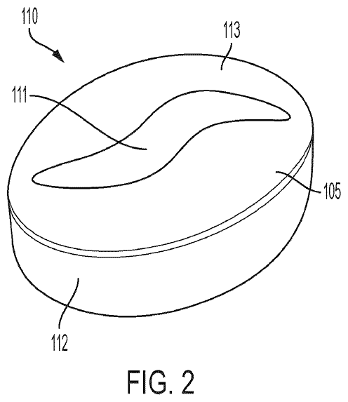

The illustrative embodiment of FIG. 2 shows another embodiment of a beverage tablet 110 in which its beverage ingredients 115 have been compacted into a tablet form. The tablet 110 has a body 113 and an outer wall 112. The body 113 and/or the outer wall 112 may be made of beverage ingredients. The tablet 110 also includes a void 111 having a serpentine shape. By contrast to FIG. 1, FIG. 2 shows a void of an asymmetric shape.

Both of the illustrative embodiments of FIGS. 1 and 2 show a void having a finite order of rotational symmetry. Both the voids of FIGS. 1 and 2 have rotational symmetry of order two.

In some embodiments, the voids may be configured to be interfaced with a post of a beverage machine to provide breakage of the tablet. In some embodiments, the void may be a through hole extending completely through the body of the tablet as shown in FIG. 1. In other embodiments, however, the void may be a blind hole extending partially through, but not entirely through, the body of the tablet. While both FIGS. 1 and 2 show only one void, in other embodiments, the beverage tablet may have a plurality of voids as the disclosure is not limited in this regard.

In some embodiments, the outer wall of the tablet may have a shape that has a finite order of rotational symmetry, as shown by the oval-shaped tablets of FIGS. 1 and 2. In some embodiments, the outer wall of the tablet may also include embossed logos or designs.

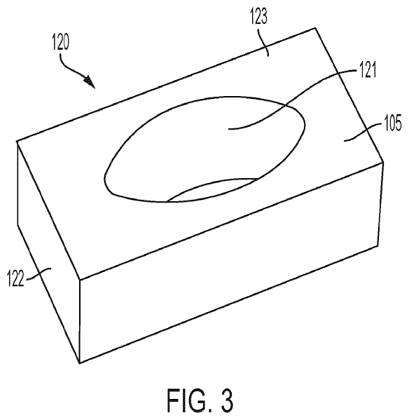

The illustrative embodiment of FIG. 3 shows another embodiment of a beverage tablet 120 in which its beverage ingredients 105 have been compacted into a tablet form. The tablet 120 has a body 123 and an outer wall 122. The outer wall in the embodiment of FIG. 3 is shaped as a rectangle. The body 123 and/or the outer wall 122 may be made of beverage ingredients. The tablet 120 also includes a void 121.

According to another aspect of the invention, a beverage tablet may have a plurality of voids. In some embodiments, the plurality of voids may provide a plurality of points of engagement with a beverage machine. The points of engagement may be used for breakage of the tablet, or for any other suitable purpose.

In some embodiments, a plurality of voids in a beverage tablet can be configured to be interfaced with a plurality of posts of a beverage machine. Such posts can, for example, be used to provide breakage of the tablet, however other suitable uses may be employed.

In some embodiments, the presence of the plurality of posts may serve to provide a plurality of points of engagement between the tablet and a beverage machine. In some embodiments, the plurality of voids may serve to anchor the tablet to posts of a beverage machine during breakage events, thereby promoting breakage of the tablet upon actuation of the posts. In some embodiments, there may an equal number of posts of a beverage machine and voids on a beverage tablet. In other embodiments, however, there may be an unequal number of posts and voids.

In some embodiments, at least one of the plurality of voids may be of a shape having a finite order of rotational symmetry (e.g., non-circular), which may be beneficial to provide traction between the posts of the beverage machine and the voids of the tablet. In such a configuration, the posts may be actuated as they are interfaced with the void, resulting in breakage of the tablet. In some embodiments, at least one of the plurality of voids may have an order of rotational symmetry of order one.

In some embodiments, the outer wall of the tablet may also have a finite order of rotational symmetry (e.g., non-circular), or may have a non-finite order of rotational symmetrical (e.g., circular). The outer wall of the tablet may also include embossed and/or debossed logos or designs.

In some embodiments, a plurality of voids may permit localized breakage events in a beverage tablet structure. This may result from selectively positioning posts in certain voids of the tablet, therefore focusing breakage on the areas of the tablet where the posts are interfaced with the voids. This may provide variations in beverage results for the end user. For example, when a compacted coffee tablet is used, localized breakage of the tablet structure may affect the strength, taste, or other characteristics of the resulting coffee beverage. In addition, the tablet may comprise multiple beverage ingredients, wherein certain sections of the tablet may be broken for use in forming a specific beverage type.

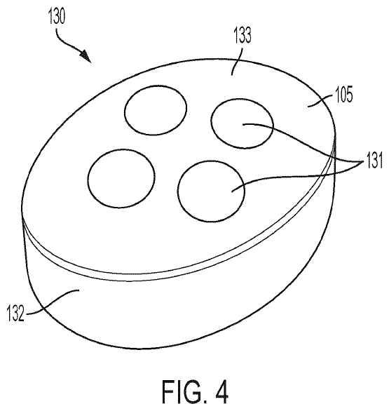

FIG. 4 shows another embodiment of a beverage tablet 130 in which its beverage ingredients 105 have been compacted into a tablet form. The beverage tablet 130 has a plurality of voids 131. The tablet has a body 132 and an outer wall 133, where the body and/or the outer wall may be made of beverage ingredients. In some embodiments, at least one of the plurality of voids may be symmetric. In other embodiments, however, at least one of the plurality of voids may be asymmetric. The plurality of voids may be distributed in the tablet in any suitable manner, as the disclosure is not limited in this regard. Additionally, in some embodiments, at least one of the plurality of voids may be a through-hole extending completely through the body of the tablet. In other embodiments, at least one of the plurality of voids may be a blind hole extending only partially through the body of the tablet.

In view of the above, the inventors have recognized that by providing variations in void shape, void depth, and the number of voids for a given tablet, a certain breakage configuration may result in the tablet following a breakage event. These possible variations in breakage configurations for the tablet may result in certain sensory attributes of the beverage following the beverage forming process. These sensory attributes may include but are not limited to variations in odor, taste, and appearance. In some embodiments, the breakage events may provide a consistent and predictable breakage of the tablet through actuation of the posts with the voids of the tablet, and in turn a consistent beverage result. For example, when a compacted coffee tablet is used, consistent breakage of the tablet can provide similar liquid diffusion throughout the tablet pieces during the brewing process, resulting in controllable beverage characteristics for the end user.

Some additional aspects of the disclosure described herein relate to the use of a beverage machine for forming a beverage from a beverage tablet. The inventors have recognized that, in some embodiments, a beverage machine may be configured to provide breakage of a beverage tablet into a plurality of pieces to yield more efficient extraction of the tablet during the beverage forming process.

According to another aspect of the invention, the inventors have recognized that a beverage machine with a brew chamber can include at least one post configured to be received in at least one void of a beverage tablet to provide breakage of the tablet into a plurality of pieces. The beverage machine may provide breakage of the tablet by moving at least one of the posts within the brew chamber relative to a wall of the brew chamber.

In some embodiments, the inventors have found that by applying a specified number of rotations and/or translations of the posts to the voids of the tablet, the number of broken tablet pieces may be selectively controlled. The inventors have appreciated that by controlling the number of tablet pieces resulting from the breakage process, beverages of a variety of types and characteristics may be produced. The characteristics that may be varied between beverages include but are not limited to amount of total dissolved solids (TDS), amount of turbidity, presence and/or absence of crema, or other characteristics as the disclosure is not limited in this regard.

The inventors have also recognized that in some embodiments, certain beverage ingredients may be disposed within the tablet that can be accessed for use in forming a beverage by selectively applying a sufficient amount of rotation and/or translation of the posts to the voids of the tablet, thereby providing breakage to the tablet to expose certain beverage ingredients. For example, if a given beverage tablet includes both coffee and ingredients for forming crema, the posts may provide a sufficient amount of breakage necessary to expose both ingredients for use in forming the beverage. In other embodiments, however, the inventors have also appreciated that certain beverage ingredients in a tablet may not be necessary for use in forming a certain beverage, and as such the sections with these ingredients may not be desired to be broken. In such a configuration, the posts may be selectively actuated to provide breakage of only sections of the tablet. For example, if the user wants to create a beverage without crema, but a given tablet contains both compacted coffee and ingredients for forming crema, then the posts may selectively provide breakage to sections in a manner that releases only coffee without exposing the ingredients for forming crema.

In some embodiments, a beverage machine may include a brew chamber configured to receive a beverage tablet. The brew chamber may have a tablet-receiving receptacle. The brew chamber receptacle may have a defined interior volume and may include a wall. The brew chamber may be of any suitable shape, size, or other characteristic for use in receiving a corresponding beverage tablet disclosed herein. The brew chamber receptacle may also include an open end and a base.

In some embodiments, the brew chamber may include at least one post configured to receive at least one void of a beverage tablet. In such a configuration, the at least one post may be actuated to provide breakage of the tablet into a number of pieces.

In some embodiments, a brew chamber may include a brew chamber lid. The lid may be moveable between an open position and closed position. In the closed position, the brew chamber lid may enclose a beverage tablet within the brew chamber. The brew chamber lid may be configured to be interfaced with an open end of the brew chamber receptacle during the beverage forming process. The brew chamber lid may further include at least one post configured to receive at least one void of a beverage tablet. In such a configuration, the at least one post may be actuated to provide breakage of the tablet into a plurality of pieces.

In some embodiments, both the brew chamber receptacle and the brew chamber lid may each include at least one post configured to receive at least one void of a beverage tablet. In other embodiments, however, only one of the brew chamber receptacle or the brew chamber lid may include at least one post configured to receive at least one void of a beverage tablet.

The illustrative embodiment of FIG. 5 shows one embodiment of a beverage machine 200 having a brew chamber 201 with a brew chamber receptacle 209 and a brew chamber lid 206. The brew chamber may include an open end 204, a wall 205, and a lower post 202 which may be disposed within the interior volume of the brew chamber, on the brew chamber receptacle 209. The brew chamber lid may also include an upper post 203. The lower post 202 and the upper post 203 may be configured to rotate and/or translate to provide breakage of a beverage tablet. For example, as shown in FIG. 5, the posts may rotate in the same direction, with both the lower post 202 and the upper post 203 rotating counterclockwise. In this configuration, the posts may serve to crush the tablet against the wall 205 of the brew chamber into a plurality of pieces. In other embodiments, the posts may both rotate in a clockwise direction, or may each rotate in opposite directions relative to one another. In some embodiments, one or more of the posts may translate as an alternative to, or in addition to, rotation.

In some embodiments, the posts may be actuated using at least one mechanism, including but not limited to a motor. In some embodiments the posts may be actuated via the mechanism to rotate relative to the wall of the brew chamber. By providing rotation of at least one post that is interfaced with at least one void of a beverage tablet, the tablet can be broken into a number of pieces.

In some embodiments, the tablet may be crushed against the walls of the brew chamber as the post rotates the tablet. For example, if only one post is received in the brew chamber and is interfaced with a single void in the tablet, the post may cause rotation of the tablet against the wall of the brew chamber, thereby crushing the tablet into a number of pieces.

Alternatively or in addition, the posts may apply shear forces to the tablet as the post rotates to provide breakage of the tablet. For example, in a configuration where a first post is received by the brew chamber and a second post is received by the brew chamber lid, both posts may interface with a single void in the tablet and rotate in opposite directions, thereby shearing the tablet into a number of pieces. In some embodiments, rotation of at least one post in the beverage machine may occur in a clockwise or counterclockwise direction as necessary to provide breakage of the tablet.

In some embodiments, the at least one post may be actuated to translate relative to the wall of the brew chamber. Translation of the post(s) may result in the tablet being crushed against the wall of the brew chamber and/or result in the tablet being subjected to shearing forces to provide breakage. In some embodiments, translation of at least one post in the beverage machine may occur in any linear direction as necessary to provide breakage of the tablet.

In some embodiments, the posts of the beverage machine may rotate and/or translate relative to the brew chamber at the same velocity and the same direction.

In other embodiments, however, relative movement between posts may give rise to tablet breakage. For example, in some embodiments, one post of the beverage machine may be stationary, while the other post moves relative to the stationary post. The stationary post may serve to anchor the beverage tablet while the moving post or plurality of posts may rotate and/or translate relative to the stationary post, thus causing the tablet to break.

As another example, both posts may move, but at different velocities and/or different directions relative to one another. The relative movement between the posts may give rise to tablet breakage. In one illustrative embodiment, one post may rotate in a first direction, while the other post may rotate in a second, opposite direction. With both posts engaged with the tablet, the relative movement between the posts may cause the tablet to break apart.

In another example, one post may translate in a first direction, while another post may translate in a second direction that is different from the first direction. The first and second directions may be opposing directions, may be orthogonal directions, or may have any other suitable angle between them, e.g. 10, 15, 45, or 135 degrees, and so on.

In yet another example, the posts may rotate and/or translate in the same direction, but at different velocities such that there is relative movement between the posts. The velocity of the posts may be selectively controlled to provide varying degrees of breakage of the corresponding tablet.

In some embodiments, at least one post of the beverage machine may be of a substantially similar shape to a corresponding void or plurality of voids of a beverage tablet. This may allow a post and void to remain engaged with one another during movement of the post. The tablet may move with the post as the post rotates and/or translates.

In other embodiments, at least one post of the beverage machine may be of a different geometric shape than at least one void of a corresponding beverage tablet. In some embodiments, a post may be configured to move relative to the void of a tablet, e.g. to exert a breakage force on the tablet from within the void of the tablet. For example, a post may be configured to rotate within the void of a tablet and/or translate within the void of the tablet (e.g. and collide against the inner wall of the void to break up the tablet). In one illustrative embodiment, a post may have a rectangular shape, while a void of a tablet may have an oval shape. The rectangular post may fit within the oval-shaped void of the tablet. When actuated, the rectangular post may rotate within the oval-shaped void of the tablet, causing the rectangular post to collide against the inner wall of the oval-shaped void of the tablet and cause the tablet to break.

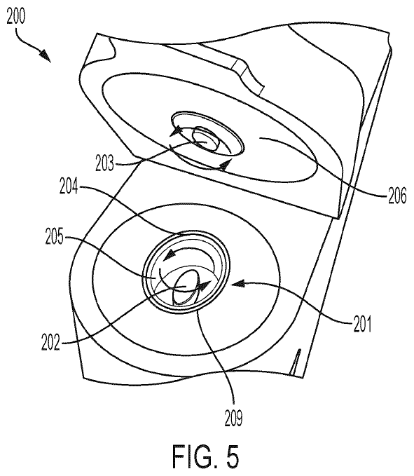

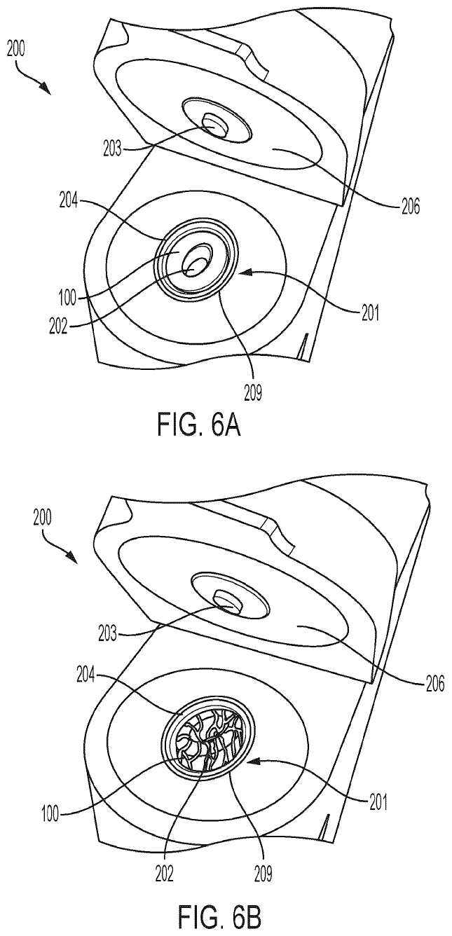

The illustrative embodiment of FIG. 6A shows the beverage machine of FIG. 5 holding a beverage tablet 100. The embodiment of FIG. 6A shows a beverage machine 200 having a brew chamber 201 with a brew chamber receptacle 209 and a brew chamber lid 206. In this embodiment, the brew chamber includes a lower post 202 configured to receive the beverage tablet 100, and an open end 204 configured to interface with the brew chamber lid. The brew chamber lid includes an upper post 203. The embodiment of FIG. 6A shows an example of the beverage tablet disposed in the beverage machine prior to breakage of the tablet. FIG. 6B shows the beverage tablet 100 after the tablet has been broken into a plurality of pieces by the beverage machine. As disclosed herein, the number of pieces of a tablet following a breakage event may be varied to produce a desired beverage type and a set of desired beverage characteristics.

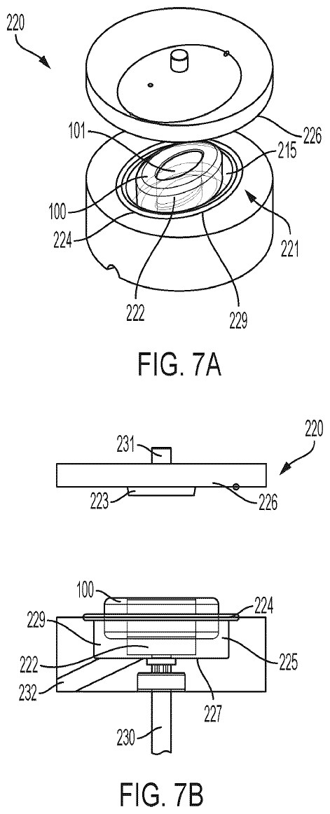

One illustrative embodiment of a beverage machine brew chamber 221 interacting with a beverage tablet 100 (shown in phantom) is shown in FIGS. 7A and 7B. FIG. 7B is a side view of the beverage machine and beverage tablet of FIG. 7A, where a brew chamber receptacle 229 is shown in cross-section. The brew chamber 221 includes the brew chamber receptacle 229 and a corresponding brew chamber lid 226.

In some embodiments, a lower post 222 may be disposed on the brew chamber receptacle 229. The lower post 222 may be configured to receive a beverage tablet 100 having a void 101 such that the lower post 222 is shaped to fit into the void 101. The brew chamber receptacle 229 may further include a brew chamber wall 225, a base 227 and an open end 224 configured to be interfaced with the brew chamber lid 226. In some embodiments, the lower post 222 may connect to a shaft 230.

As seen in FIG. 7B, in some embodiments, an upper post 223 may be disposed on the brew chamber lid 226. The upper post 223 may be shaped to fit into the void 101 of a beverage tablet 100. In some embodiments, the upper post 223 may connect to a shaft 231.

Shaft 230 and/or shaft 231 may be mechanically actuated by at least one mechanism as described above (e.g. motor) to provide breakage of the tablet. While this illustrative embodiment shows the use of shafts to connect the posts to an actuation mechanism, any suitable arrangement may be used to move the posts as the disclosure is not limited in this regard.

Following breakage of the beverage tablet, a beverage precursor liquid (e.g. hot or cold water), may be diffused through the broken tablet pieces, thereby forming a desired beverage. The resulting infused beverage may be directed through an outflow channel 232. The outflow channel 232 may itself serve as a dispensing outlet out of the beverage machine, or may lead to a dispensing outlet out of the beverage machine.

In some embodiments, a beverage machine may utilize a plurality of posts to interact with tablets having a plurality of voids. The beverage machine may include a plurality of posts located on the brew chamber receptacle, the brew chamber lid, or both. The plurality of posts may be arranged in any suitable configuration as the disclosure is not limited in this regard. For example, in some embodiments, there may be 1, 2, 3, 4, or 5 or more posts disposed on the brew chamber receptacle, while there may be 1, 2, 3, 4, or 5 or more posts disposed on the brew chamber lid.

In some embodiments, groups of posts may extend from a common hub. In some embodiments, the hub may be a flat plate. The hub may be circular, square, rectangular, oval, or any other suitable shape. In some embodiments, the hub may be disposed on the brew chamber receptable or on the brew chamber lid. In certain embodiments, both the brew chamber and brew chamber lid may include a hub.

In some embodiments, any number of the plurality of posts disposed on a hub may be configured to be interfaced with a plurality of voids of a beverage tablet. In certain configurations, there may be an equal number of posts on the hub as there are voids in the tablet. In other configurations, there may be an unequal number of posts as compared to the number of voids. In some embodiments, the entirety of the hub may rotate and/or translate to provide breakage of the tablet. In other embodiments, individual posts disposed on the hub may rotate and/or translate relative to other posts to provide localized breakage of sections of the tablet.

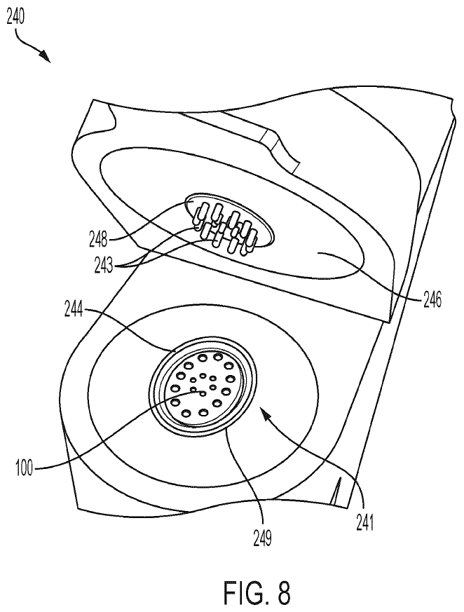

The illustrative embodiment of FIG. 8 shows one embodiment of a beverage machine 240 including a plurality of posts 243 disposed on a hub 248 that is disposed on a brew chamber lid 246. The brew chamber 241 includes a brew chamber receptacle 249. The brew chamber 241 is depicted holding a tablet 100 having a plurality of voids. The brew chamber further includes an open end 244 of the brew chamber which may be covered by the brew chamber lid 246 when the lid is in the closed position. During the tablet breakage process, the plurality of posts on the hub may interface with the plurality of voids of the tablet to provide breakage of the tablet upon actuation of the posts and/or hub. While this illustrative embodiment shows a hub on only the brew chamber lid, it should be appreciated that other arrangements are possible. For example, in some embodiments, a hub is positioned on the brew chamber receptacle. In other embodiments, a first hub is positioned on the brew chamber lid, while a second hub is positioned on the brew chamber receptacle.

According to another aspect of the invention, the inventors have recognized that a system may be provided that includes both a beverage tablet and a beverage machine for use in forming a beverage product. The inventors have appreciated that any embodiments of the beverage tablet and beverage machine disclosed herein may employed and/or combined in any suitable arrangement for use in the system as the disclosure is not limited in this regard.

In some embodiments, the system may further include a plurality of components for use in forming a beverage, including but not limited to, a water reservoir, a water dispenser head, a beverage dispenser outlet, a beverage machine housing, a drip tray, or any other suitable component to assist in the beverage forming process.

In some embodiments, the user may form a desired beverage using a specified procedure for the beverage forming process, of which the procedure may include, but is not limited to the following steps. First, the user may position a beverage tablet such that at least one void of the tablet is interfaced with at least one post of the beverage machine. In this step, the user may move the brew chamber lid to a closed position to enclose the tablet within the brew chamber. Second, the actuation mechanism may provide a specified amount of breakage to the beverage tablet. Third, a beverage precursor liquid, such as hot or cold water, may be supplied from the water reservoir through the water dispenser head to the brew chamber. Fourth, the water may interact with the tablet to form a desired beverage. Fifth, the formed beverage may be dispensed through a beverage dispenser outlet to provide a beverage to the user.

In some embodiments, portions of the beverage tablet may remain in the brew chamber following the beverage forming process. For example, in using a compacted coffee tablet comprising coffee grounds, spent grounds may remain in the brew chamber following brewing of the coffee beverage. In such a configuration, the user may remove spent tablet portions from the brew chamber using their hand and/or a tool. In some embodiments, a receptacle of the brew chamber may be removable for use in disposal of the spent tablet portions. In further embodiments, the beverage tablet may comprise soluble coffee as disclosed herein. In this configuration, the entirety of the tablet may dissolve when contacted with water during the beverage forming process, thereby resulting in no spent tablet portions remaining in the brew chamber.

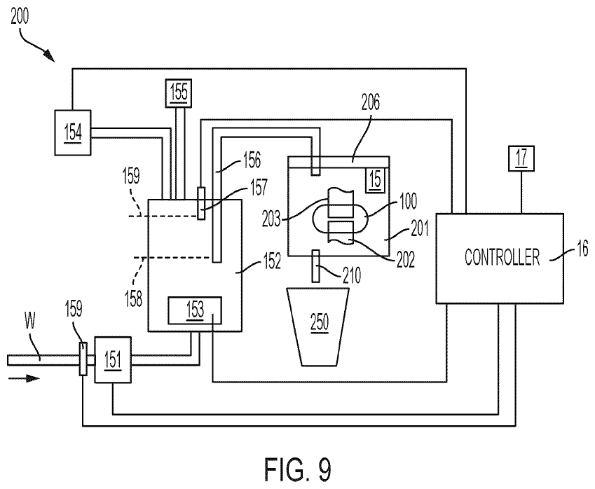

FIG. 9 shows a schematic block diagram of various components that may be included in a beverage machine 200 in one illustrative embodiment. Those of skill in the art will appreciate that a beverage machine 200 may be configured in a variety of different ways, and thus aspects of the invention should not be narrowly interpreted as relating only to one type of beverage machine. In this embodiment, a precursor liquid (e.g. hot or cold water) may be supplied from a liquid supply (e.g. a water reservoir) to a brew chamber 201. A brew chamber lid 206 may be included to enclose the brew chamber 201. A beverage tablet 100 comprising one or more beverage ingredients (e.g. coffee grounds, soluble coffee, tea leaves, etc.) may be included for use in forming the beverage. Following breakage of the beverage tablet 100 using a lower post 202 and an upper post 203 that are interfaced with a void of the tablet, the tablet pieces may be mixed with the precursor liquid from the liquid supply to form a desired beverage. The beverage may then be dispensed to a container 250 using a beverage machine dispenser outlet 210. In this embodiment, the lower post 202 may be secured to the brew chamber 201, and the upper post 203 may be secured to the brew chamber lid 206. While the use of two posts on opposite sides of the brew chamber are shown in this illustrative embodiment, any suitable post arrangement may be used, for example, only one post, two posts on the same side of the brew chamber, or more than two posts in any arrangement, as disclosed herein.

The liquid supply in this embodiment controls the volume of liquid provided to the brew chamber 201 by filling a tank 152 to a liquid dispense level 159 and then pressurizing the tank 152 by way of an air pump 154 so that liquid in the tank 152 is forced out of the conduit 156 to the brew chamber 201. The volume of liquid delivered to the brew chamber 201 is equal to the volume in the tank 152 between the liquid delivery level 159 and a post-delivery level 158 at a bottom of the conduit 156 in the tank 152. Since there is one delivery level 159 in this embodiment, one volume can be provided to the brew chamber 201. However, two or more delivery levels may be used.

In this embodiment, the liquid supply provides liquid to the tank 152 via a valve 151 that is coupled to a source W. The source W may have any suitable arrangement, e.g., may provide liquid from a removable or fixed storage tank, a mains water supply or other source. Thus, in some cases, the liquid provided to the tank 152 may vary in temperature by a wide degree depending on various factors, such as time of year, a temperature of a room in which the beverage machine 200 is located, etc. For example, if the source W is a reservoir that is filled by a user, the temperature of liquid in the reservoir may vary between room temperature (e.g., if liquid sits in the reservoir for an extended time) and a cooler temperature (e.g., if the reservoir has just been filled with water that is dispensed from a tap).

To provide liquid to the tank 152 in this embodiment, the valve 151 is controlled by the control circuit 16 to open and close to provide a desired volume of liquid to the tank 152. For example, if the tank 152 is empty or at the post-dispense level 158, the valve 151 may be opened until a conductive probe or other liquid level sensor 157 provides a signal to the control circuit 16 that indicates when liquid arrives at the dispense level 159. In response to the level sensor 157 detecting liquid at the sensor 157, the control circuit 16 may close the valve 151. Of course, other arrangements are possible, such using a pump to move liquid from a storage reservoir to the tank 152.

Although in this embodiment the liquid level sensor includes a conductive probe capable of contacting liquid in the tank 152 and providing a signal (e.g., a resistance change) indicative of liquid being present at respective dispense level 159 in the tank 152, the liquid level sensor may be arranged in other ways. For example, the sensor may include a microswitch with an attached float that rises with liquid level in the tank 152 to activate the switch. In another embodiment, the liquid level sensor may detect a capacitance change associated with one or more liquid levels in the tank, may use an optical emitter/sensor arrangement (such as an LED and photodiode) to detect a change in liquid level, may use a pressure sensor, may use a floating magnet and Hall effect sensor to detect a level change, and others. Thus, the liquid level sensor is not necessarily limited to a conductive probe configuration. Moreover, the liquid level sensor may include two or more different types of sensors to detect different levels in the tank. For example, a pressure sensor may be used to detect liquid at a dispense level (e.g., complete filling of the tank 152 may coincide with a sharp rise in pressure in the tank 152), while a conductive probe may be used to detect liquid at the other dispense level 159.

Further, a liquid level sensor need not be used to fill the tank to the dispense level 159. Instead, other techniques may be used to suitably fill the tank 152, such as opening the valve 151 for a defined period of time that is found to correspond to approximate filling of the tank 152 to the desired level. Of course, other arrangements for providing liquid to the tank 152 are possible, such as by a pump (e.g., a centrifugal pump, piston pump, solenoid pump, diaphragm pump, etc.), gravity feed, or other, and the way by which the tank is filled to the dispense level 159 may depend on the technique used to provide liquid to the tank. For example, control of a volume of liquid provided to fill the tank 152 to the dispense level 159 may be performed by running a pump for a predetermined time, detecting a flow rate or volume of liquid entering the tank 152 (e.g., using a flow meter), operating a pump for a desired number of cycles (such as where the pump is arranged to deliver a known volume of liquid for each cycle), detecting a pressure rise in the tank 152 using a pressure sensor, or using any other viable technique.

Liquid in the tank 152 may be heated by way of a heating element 153 whose operation is controlled by the control circuit 16 using input from a temperature sensor or other suitable input. Also, the tank 152 may be arranged as a flow-through heater that has a relatively small volume, e.g., a tube with associated heating element to heat liquid in the tube. Of course, heating of the liquid is not necessary, and instead (or additionally) the beverage machine 200 may include a chiller to cool the liquid, a carbonator to carbonate the liquid, or otherwise condition the liquid in a way that alters the volume of liquid in the tank 152. (Generally speaking, components of the liquid supply that heat, cool, carbonate or otherwise condition liquid supplied to the brew chamber 201 are referred to as a “liquid conditioner.”)

In this embodiment, liquid may be discharged from the tank 152 by an air pump 154 operating to force air into the tank 152 to pressurize the tank and force liquid to flow in the conduit 156 to the brew chamber 201. Since the conduit extends downwardly into the tank 152, the volume of liquid delivered to the brew chamber 201 is defined as the volume in the tank 152 between the dispense level 159 and the bottom end of the conduit 156. Again, liquid may be caused to flow from the tank 152 to the brew chamber 201 in other ways. For example, a pump may be used to pump liquid from the tank 152 to the brew chamber 201, a pump could force liquid into the tank 152 which causes liquid in the tank to move to the brew chamber 201, liquid may be allowed to flow by gravity from the tank 152, and others. A volume of liquid delivered from the tank to the brew chamber 201 may be controlled based on a volume of liquid forced into the tank 152, which may be detected by a flow meter, pump cycles, etc. A vent 155, which can be opened or closed to vent the tank 152, may be provided to allow the tank 152 to be filled without causing a substantial rise in pressure in the tank 152 and to allow liquid to be delivered from the tank 152 by pressurizing the tank using the air pump 154. In some embodiments, the vent 155 is not controlled by the control circuit 16 but remains always open with an orifice of suitable size to allow venting for filling of the tank 152, and air pressure buildup in the tank 152 to allow liquid delivery. In other embodiments, however, the vent 155 can be open and closed by a controller. Other flow control features may be provided as well, such as a check valve or other flow controller that can prevent backflow in the conduit between the source W and the tank 152, or between the tank 152 and the brew chamber 201.

Operation of the valve 151, air pump 154 and other components of the beverage machine 200 may be controlled by the control circuit 16, e.g., which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface 17), communication buses or other links, a display, switches, relays, triacs, or other components necessary to perform desired input/output or other functions. A user interface 17 may be included to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

As shown in FIG. 9, a reading device 15 may also be included in the beverage machine 200. The reading device 15 may be arranged to identify at least one characteristic of the tablet. In some embodiments, the reading device 15 may be able to determine characteristics relating to the voids, e.g. the position, size, shape, and/or depth of the voids.

The inventors have additionally recognized that benefits may be realized by providing one or more ribs located along the interior of a chamber of a beverage machine to help facilitate breakage of a beverage ingredient tablet, where the chamber is configured to receive the beverage ingredient tablet. In some embodiments, this chamber may be the brew chamber, and in other embodiments, the beverage machine may have a brew chamber that is downstream of this chamber. Specifically, the inventors have found that providing one or more ribs in the interior of the chamber in conjunction with one or more posts of the beverage machine may serve to enhance breakage of the beverage ingredient tablet due to contact of the tablet against the ribs. Accordingly, the use of ribs in a beverage machine may serve to provide a greater plurality of broken tablet pieces, thereby enabling different extraction yields of the beverage product to be provided to the end user.

In some embodiments, the one or more ribs may be located along a sidewall of the interior of the chamber. In some such embodiments, the ribs may be positioned along the entirety of the chamber sidewall. In other embodiments, however, the ribs may be positioned at regular or irregular intervals along the chamber sidewall with portions of smooth sidewall being disposed between the ribs.

The one or more ribs may be of any suitable shape to facilitate breakage of the beverage ingredient tablet. In some embodiments, a suitable rib shape includes, but is not limited to triangular prisms, rectangular prisms, trapezoidal prisms, lune-shaped prisms, or any other suitable rib shape as the disclosure is not so limited. Without wishing to be bound by theory, combinations of rib shapes are also possible. For example, a plurality of triangular prism-shaped and rectangular prism-shaped ribs may be regularly or intermittently arranged with one another along the chamber sidewall. While this specific example is disclosed, it is to be understood that any suitable rib shape or combination thereof may be employed for use in the chamber of the beverage machine to facilitate breakage of the beverage ingredient tablet.

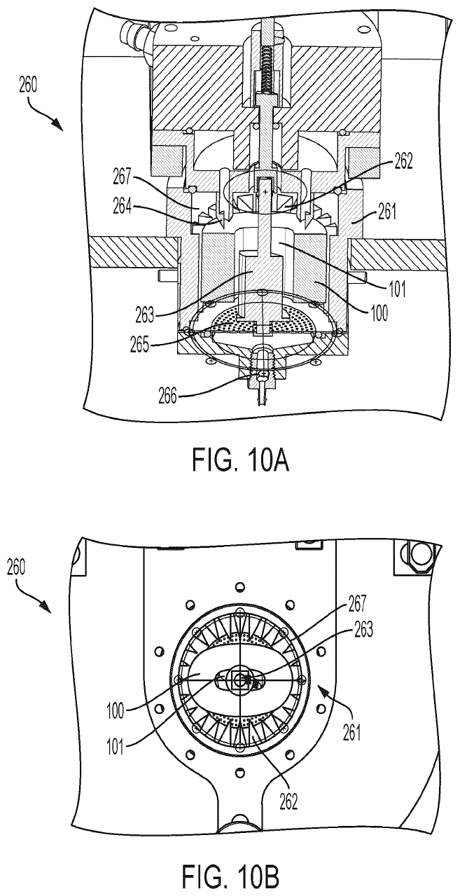

The one or more ribs may also be of any suitable size to facilitate breakage of the beverage ingredient tablet. The ribs may extend from the sidewall of the chamber in a direction substantially perpendicular to an outer wall of the beverage ingredient tablet at a distance of greater than or equal to 0.1 mm, 0.3 mm, 0.5 mm, 0.75 mm, 1 mm, 1.5 mm, 2 mm or greater. The ribs may also extend any suitable distance along a height and/or circumference of the sidewall of the chamber. In some embodiments, a rib may extend along the entire height of the sidewall, half the height of the sidewall, a quarter of the height of the sidewall, or any other suitable distance. In some embodiments, a rib may extend along the circumference of the sidewall at a distance of greater than or equal to 0.1 mm, 0.2 mm, 0.3 mm, 0.4 mm, 0.5 mm, 0.6 mm, 0.7 mm, 0.8 mm, 0.9 mm, 1 mm, 1.5 mm, 2 mm, 2.5 mm, or greater. In some embodiments, a plurality of ribs may be disposed along the sidewall of the chamber, and each of the plurality of ribs may have the same or different sizing as one another as the disclosure is not limited in this regard. For example, the plurality of ribs may be formed such that a certain portion of the sidewall has smaller ribs and a different portion of the sidewall has larger ribs (e.g., see FIG. 10A-B). Combinations of the foregoing rib sizes may also be used as the disclosure is not so limited.

FIG. 10A shows a cross-section view of an embodiment of a beverage machine 260 including a brew chamber 261 and a plurality of ribs 262 located along the interior sidewall 267 of the brew chamber 261. A beverage ingredient tablet 100 includes a void 101 and is disposed within the brew chamber 261. A post 263 of the beverage machine 260 is shown in FIG. 10A to interface with the void 101 of the beverage ingredient tablet 100. The post 263 may be actuated to provide breakage to the tablet 100 by rotating and/or translating the tablet 100 relative to the corresponding ribs 262 located along the sidewall 267 of the brew chamber 261. As described above, as the post 263 of the beverage machine 260 rotates to turn the tablet, the tablet contacts the ribs 262, resulting in breakage of the tablet. Following breakage of the tablet 100 into a specified number of pieces, a precursor liquid (e.g., hot or cold water) may be dispensed from conduits 264 to percolate through the broken beverage ingredient tablet pieces to form a beverage which is then dispensed through holes formed in a baseplate 265 and out of a beverage dispenser outlet 266. A corresponding beverage container may be positioned for receiving the dispensed beverage from the beverage dispenser outlet 266. In some embodiments, spent beverage ingredient tablet pieces (e.g., spent ground coffee) may be retained on the baseplate 265 following the brewing process, which may then be disposed of by an end user.

FIG. 10B shows a top view of the brew chamber 261 of beverage machine 260 of FIG. 10A. The brew chamber 261 has a plurality of ribs 262 located along the interior sidewall 267 of the brew chamber 261. A void 101 of a beverage ingredient tablet 100 is interfaced with a post 263 which is configured to provide breakage of the beverage ingredient tablet 100 into a specified number of pieces. As can be seen in FIG. 10B, the ribs 262 are positioned along the chamber sidewall 267 with varied spacing between the ribs 262. The ribs 262 are also of a variety of different sizes which may serve to promote breakage of the tablet 100 as the tablet contacts each of the various ribs 262.

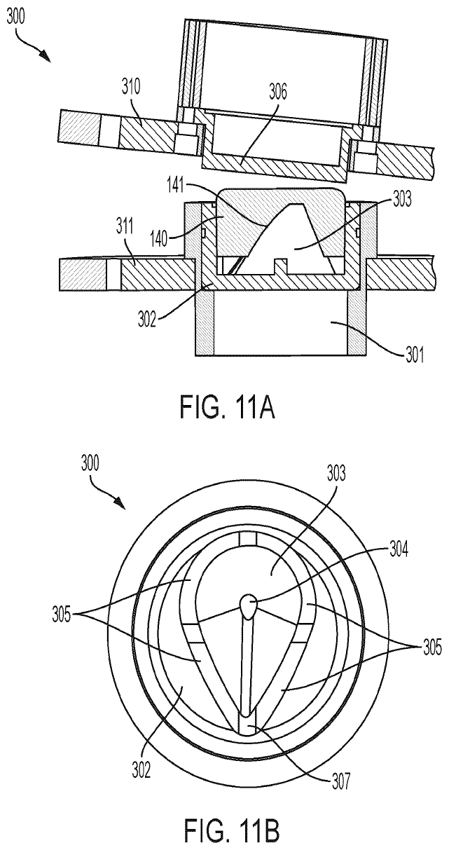

According to one aspect, a tablet may be crushed by applying a compressive force to the tablet. In some embodiments, the tablet may rest on a post while being crushed. A chamber lid or other compression surface (such as a piston) of a beverage machine may be used to provide a downward compressive force when closing or otherwise moving toward the tablet to provide breakage of the tablet against the one or more posts and/or a surrounding chamber receptacle of the beverage machine. In some such embodiments, the beverage ingredient tablet may include one or more voids, and the one or more voids may be configured as one or more blind holes such that the tablet may be positioned and retained on the one or more posts (e.g., see FIG. 11A). In other embodiments, however, the one or more voids may be configured as through holes. For example, a singular void may extend entirely through the tablet, but may be tapered or otherwise shaped such that the tablet can still be retained on a corresponding stationary post to position the tablet such that it may be crushed by the chamber lid. In some embodiments, the post(s) on which the tablet is supported may be stationary. In other embodiments, the post(s) may be moveable relative to the chamber, e.g. may rotate and/or translate.

In some embodiments, the chamber lid and/or the chamber itself may include one or more handles that an end user may grasp to close the chamber lid relative to the chamber receptacle, which may thereby provide breakage of a beverage ingredient tablet as disclosed above. In some such embodiments, the compressive force exerted on the tablet may be manually provided by the end user. In other embodiments, however, the actuation to enclose the chamber lid to provide breakage of the tablet may be automated (e.g., through suitable electromechanical actuators).

In some embodiments, the geometry of the one or more posts may complement the geometry of the one or more voids (e.g., blind holes) formed in the beverage ingredient tablet. For example, a single post may be integrally formed or otherwise connected to the base of the chamber receptacle, and the post may be tapered such that the post is wider at the base and narrower at the top. In such an example, the beverage ingredient tablet may include a singular void that is of an inversely tapered shape relative to the tapered shape of the post. This may allow the tablet to be fitted onto the post prior to breakage of the tablet via compressive force applied from the chamber lid (see FIG. 11A). While the above example is disclosed, the one or more posts and the one or more voids of the beverage ingredient tablet may be of any suitable shape including, but not limited to: rectangular prisms, cylindrical, elliptic cylinders, triangular prisms, trapezoidal prisms, teardrop-shaped, or any other suitable shape as the disclosure is not so limited.

In some embodiments, the chamber in which the beverage ingredient tablet is crushed may comprise a brew chamber. In some such embodiments, the crushed beverage ingredient tablet pieces may remain in the brew chamber receptacle, and a beverage precursor liquid (e.g., hot water) may be dispensed into the brew chamber receptacle to brew a beverage for the end user.

In some embodiments, the beverage ingredient tablet may be crushed in a chamber that is separate and distinct from a brew chamber. The brew chamber may be downstream from the crush chamber. In some embodiments, beverage tablet pieces may fall into or otherwise move from the crush chamber into the brew chamber after the tablet is crushed in the crush chamber. In some embodiments, the beverage precursor liquid may be sent into the brew chamber but not into the crush chamber. In other embodiments, however, the beverage precursor liquid may flow through the crush chamber and into the brew chamber.

In some embodiments, the beverage ingredient tablet may be first crushed in a brew chamber receptacle as described herein, and then the crushed tablet pieces may fall through one or more cavities formed in the brew chamber receptacle into a secondary portion of the brew chamber for brewing the beverage. In some such embodiments, one or more cavities may be formed adjacent to a base of the one or more posts that may be provided in the chamber receptacle such that the broken tablet pieces are naturally urged to fall through the cavities. The brew chamber receptacle itself may also include features to urge broken tablet pieces to fall through the cavities. For example, the base of the brew chamber receptacle may be tapered to further urge broken tablet pieces to fall into the cavities. After the broken tablet pieces fall into the secondary portion of the brew chamber, a beverage precursor liquid (e.g., hot water) may be dispensed through the broken tablet pieces to brew a beverage for the end user.

In some embodiments, the chamber (e.g., the crush chamber, brew chamber, or combined) receptacle is removable from the beverage machine. This may be beneficial, for example, to access and remove spent grounds which may be disposed in the chamber. The chamber receptacle being removable may also provide the added benefit of differently shaped chamber receptacles and/or posts to be interchanged with one another to provide a different breakage and brewing experience for the end user. In some embodiments, the chamber receptacle may remain within the beverage machine, but the posts themselves may be interchanged with other post shapes and/or sizes to provide a different breakage result of the beverage ingredient tablet.

In some embodiments, the chamber receptacle may have a mechanism configured to close off the one or more cavities that may be formed in the chamber receptacle such that the crushed tablet pieces may remain in the receptacle rather than fall into a secondary portion of the chamber (or fall into a second chamber such as a brew chamber). The one or cavities may be closed off using any suitable method. For example, a covering may be actuated between a retracted and an extended position to uncover and cover the one or more cavities, respectively.

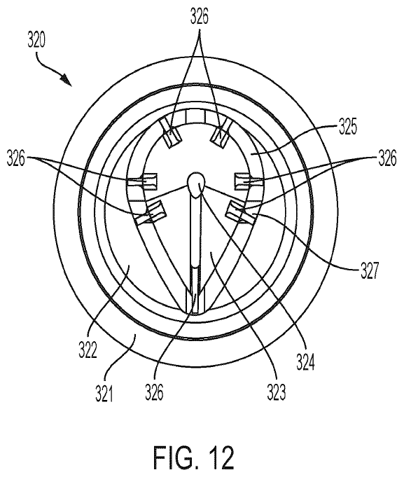

In some embodiments, the one or more posts and/or the chamber receptacle may include one or more fins configured to further facilitate breakage of the beverage ingredient tablet when compressed (e.g., see FIG. 12). The one or more fins may be positioned along any suitable location within the chamber receptacle to selectively influence the amount of breakage of the beverage ingredient tablet following the application of compressive force from the chamber lid or other compression member (e.g. a piston). The one or more fins may also be integrally formed or separately attached to the chamber receptacle and/or the one or more posts as the disclosure is not so limited. In some embodiments, the shape, size, location, and/or any other suitable characteristic of the fins may be chosen to maximize breakage of the regions of the tablet which may experience the least breakage due to the shape of the posts and/or the shape of the tablet. For example, if an asymmetric post is provided in the chamber receptacle, one side of the tablet may experience less breakage than the other side of the tablet. As such, the fins may be selectively positioned to provide increased breakage of that side of the tablet. The fins may also be of any suitable shape, including but not limited to triangular prisms, rectangular prisms, trapezoidal prisms, lune-shaped prisms, or any other suitable shape as the disclosure is not so limited.

FIG. 11A shows a cross-section view of a beverage machine 300 and a beverage tablet 140 disposed within the beverage machine 300. In particular, the beverage tablet 140 includes a singular void configured as a blind hole, which is received by a single post 303 within a chamber receptacle 302. In some embodiments, the post is stationary. In other embodiments, however, the post may be configured to move, e.g. rotate and/or translate. The post 303 is tapered such that the post 303 is wider at its base and narrower at its top. The blind hole 141 of the beverage tablet 140 is inversely tapered such that it has a complementary geometry to that of the post 303. The beverage machine further includes a chamber lid 306 which is positioned above the chamber receptacle 302. In some embodiments, a user may push down on and/or grasp surface 310 of the chamber lid 306 to close the chamber lid 306 onto the chamber receptacle 302. In some embodiments, the surface 310 may comprise a handle. Closure of the chamber lid pushes the tablet 140 down onto the post 303, thereby crushing the tablet into pieces. In some embodiments, a bottom surface of the lid 306 may directly contact and push down on the tablet. As noted above, the one or more voids of the beverage tablet and the one or more posts may be constructed and arranged in any suitable fashion to provide breakage to the tablet as the disclosure is not so limited.

FIG. 11B shows a top view of the chamber receptacle 302 of FIG. 11A with the beverage tablet 140 and the chamber lid 306 removed for clarity. As detailed above, the beverage machine 300 includes a chamber receptacle 302 as well as a post 303 positioned within the chamber receptacle 302. The post 303 is constructed and arranged to be tapered such that the base is wider than the top 304. As can be seen in FIG. 11B, the chamber receptacle 302 includes cavities 305 positioned around the base of the post 303. In some embodiments, a plurality of extensions 307 may be used to support the post in the chamber receptacle 302. The tapered shape of the post 303 may urge broken tablet pieces to fall through the cavities 305 and into a brew chamber 301 where the broken tablet pieces may then be exposed to a beverage precursor liquid (e.g., hot water) to brew a selected beverage. The brewed beverage may than be dispensed for the end user.

FIG. 12 shows a top view of a chamber receptacle 322 of a beverage machine 320 which is similar to the chamber receptacle of FIG. 11B. The beverage machine 320 includes a chamber receptacle 322 with a post 323 positioned within the chamber receptacle 322. The post 323 is tapered such that it is wider at its base and narrower at its top 324. The chamber receptacle 322 also includes cavities 325 positioned around the base of the post 323, where broken tablet pieces may fall through the cavities 325 and into a brew chamber 301 where the beverage may then be brewed. A plurality of extensions 327 may support the post 323 within the chamber receptacle 322. However, unlike the embodiment of FIG. 11B, the beverage machine 320 includes a plurality of fins 326 positioned within the chamber receptacle 322. The fins 326 may be of any suitable size, shape, location, or any other suitable characteristic as noted above as the disclosure is not so limited. As disclosed herein, the inventors have recognized that the addition of fins may serve to enhance breakage of the beverage ingredient tablet upon the application of compressive force from the chamber lid.

According to one aspect, a beverage machine may be configured to break a beverage tablet by first crushing the tablet into pieces using a compressive force while the tablet rests on one or more posts, and then the post(s) may rotate to further crush the pieces into smaller pieces. In some embodiments, a post may include blades to assist with further crushing the pieces into smaller pieces as the post turns.

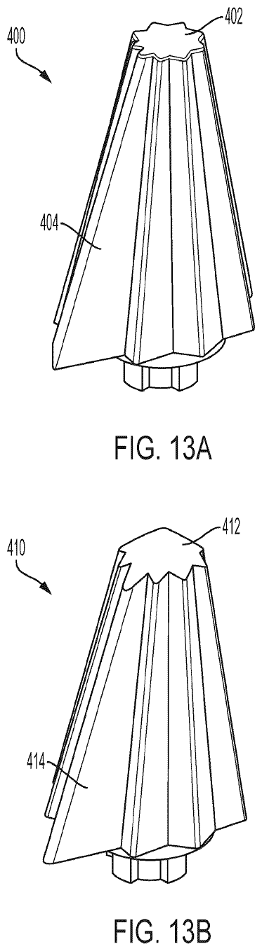

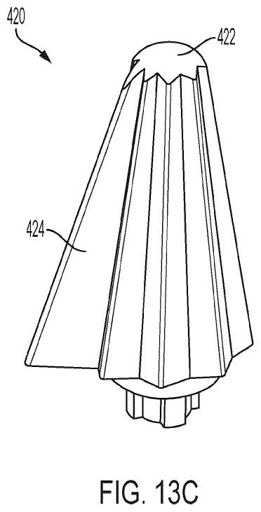

In some embodiments, the arrangement shown in FIGS. 11A and 11B may be modified to utilize a rotatable post. In some embodiments, the post may include blades to facilitate breakage. Illustrative examples of such posts are shown in FIGS. 13A-13C. The breakage posts each have a plurality of blades 404, 414, 424 extending outwardly from a center of the breakage post.

In some embodiments, a beverage tablet resting on the post may first be broken due to compressive stress on the tablet. As previously described with respect to FIGS. 11A and 11B, a chamber lid or other compressive surface of a chamber may close onto the tablet to crush the tablet down onto the post, breaking the tablet into pieces. The tablet pieces may fall into spaces between the post blades and the chamber sidewall. The post may then be actuated to turn, causing the tablet pieces to be further crushed between the post blades and the chamber sidewall.

In some embodiments, the chamber sidewall may include surface features to facilitate this additional crushing step. For example, the chamber sidewall may include ribs such as those shown in FIGS. 10A and 10B. As the post turns, the tablet pieces are crushed between the post blades and chamber sidewall ribs into smaller pieces.

These smaller pieces may drop down into a brewing area in which a beverage precursor liquid will be introduced to the pieces to form the beverage. In some embodiments, the beverage precursor liquid may also pass through the area where the tablet is crushed so as to flush broken pieces into the brewing area. In some embodiments, a single brew chamber houses both the crushing area and the brewing area. In other embodiments, however, the crushing area is in a crushing chamber that is separate and distinct from the brew chamber.

While a plurality of blades is shown in FIGS. 13A-C, in some embodiments only one blade may extend outwardly from a center of the breakage post. The blades may also be of any suitable length, shape, thickness, or other suitable characteristic to assist in providing breakage of a corresponding beverage tablet. For example, as shown in FIGS. 13A-C, the blades may be constructed and arranged to substantially complement a corresponding shape of a chamber receptacle (e.g., a teardrop shape, a circular shape, etc.). That is, certain blades may have a greater length than others to complement the shape of the chamber receptacle.

The breakage posts shown in FIGS. 13A-13C have different top surface shapes. This top surface may interact with a blind hole of a beverage tablet. In some embodiments, as shown in FIG. 13A, a breakage post 400 may have a flat top 402. This may, in some cases, help promote stability of a tablet on the post. In other embodiments, as shown in FIG. 13B, a breakage post 410 may have a pointed top 412. This may, in some cases, help to facilitate breakage of the tablet when a compressive force is applied. In some embodiments, as shown in FIG. 13C, a breakage post 410 may have a rounded top 422. This may, in some cases, help promote stability of a tablet while also facilitate breakage of the tablet when a compressive force is applied. It should be appreciated that the top portion of the breakage posts may be of any suitable shape to facilitate engagement within a corresponding void of a beverage tablet. For example, the top portion may be flat, rounded, pointed, as described above, or any other suitable shape (e.g., trapezoidal, pyramidal, hexagonal, a cone, etc.). Accordingly, the void of the beverage tablet may be constructed and arranged to be of a complementary shape to that of the breakage post to facilitate engagement and breakage due to twisting and crushing of the tablet relative to the chamber.

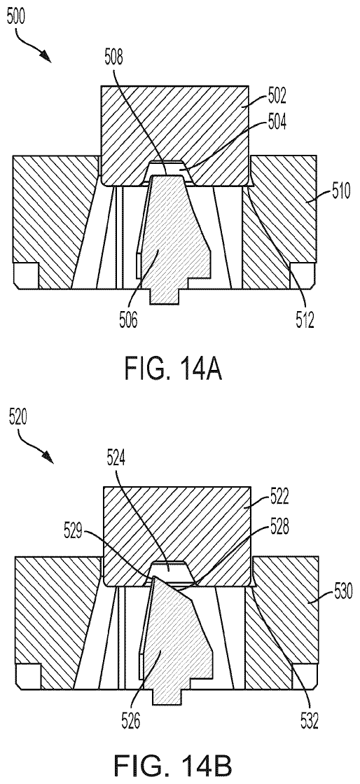

FIGS. 14A-B show embodiments of a portion of a beverage machine where the engagement between a breakage post and a blind hole of a beverage tablet is shown. In particular, FIG. 14A shows an illustrative embodiment of a beverage machine 500 having a chamber 510 within which a beverage tablet 502 and a breakage post 506 are positioned. The breakage post 506 has a flat top portion 508 that is configured to be received by a complementary blind hole 504 of the tablet 502. FIG. 14B shows another illustrative embodiment a beverage machine 520 having a chamber 530 within which a beverage tablet 522 and a breakage post 526 are positioned. In contrast to FIG. 14A, the breakage post 526 of FIG. 14B has a slanted top portion 528 that is configured to be received by a blind hole 524 of the tablet 522. The slanted top portion 524 may include a pointed portion 529. Without wishing to be bound by theory, including a pointed portion 529 at the top of the post may assist with breakage of the beverage tablet (e.g., may facilitate breakage of the tablet during crushing).

The slanted top portion may be at any suitable angle, and the top portion may be of other suitable shapes as disclosed herein. In some embodiments, the top portion may be conical, and may include a pointed tip. The breakage posts may also be of any suitable height or other dimensional parameters to permit engagement with the corresponding void of the beverage tablet.

In some embodiments, as seen in FIGS. 14A, 14B, the chamber may include one or more supporting ledges 512, 532 to retain the beverage tablets 502, 522 in a desired position. The supporting ledges may serve to support an outer portion of the tablet, while the post 506 may serve to support a central portion of the tablet.

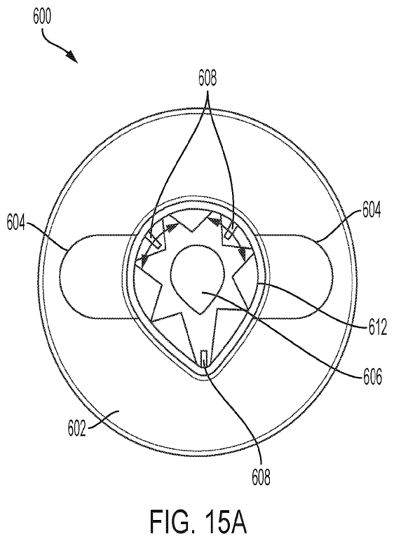

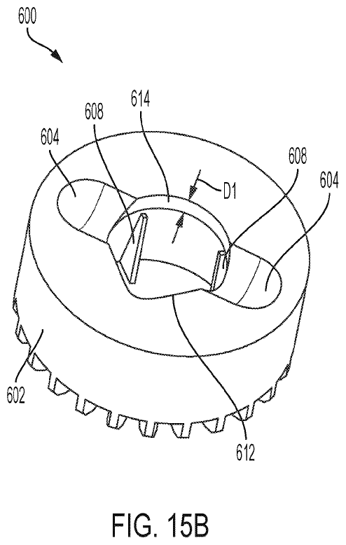

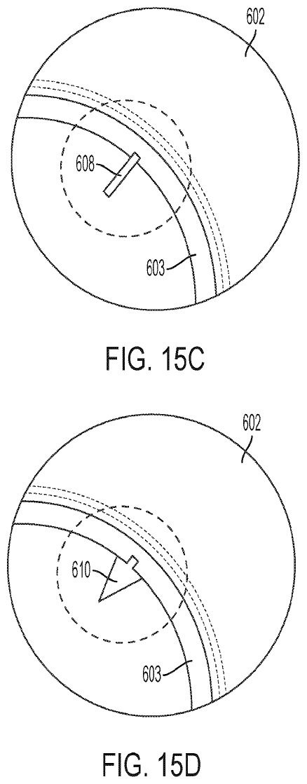

FIG. 15A shows a top view of a tablet-receiving chamber 602 of a beverage machine 600 including a plurality of supporting ledges 608. The supporting ledges 608 may assist in increasing stability of a corresponding beverage tablet when the tablet is retained within a receptacle 612 of the chamber 602.

In some embodiments, the chamber 602 may include one or more recesses 604 which may serve to assist a user in gripping a beverage tablet positioned within the receptacle 612 to remove the tablet. A breakage post 606 is also provided within the receptacle 612 of the chamber 602 and is configured to provide breakage of a beverage tablet into a plurality of pieces by facilitating twisting and/or crushing the tablet. In some embodiments, such as the embodiment shown in FIG. 15A, the post 606 is teardrop-shaped and may be configured to be received into a blind hole of a beverage tablet. The post may support the tablet during crushing and/or may rotate to break the tablet.

In some embodiments, a void of a beverage tablet, (e.g. a blind hole or a through hole), may be teardrop-shaped. A teardrop-shaped post may thus be sized and shaped to interact with the teardrop-shaped void of a beverage tablet.

In some embodiments, such as the embodiment shown in FIG. 15A, the receptacle 612 is teardrop-shaped and may be configured to receive beverage tablets having a teardrop-shaped outer wall. However, it should be appreciated that, in other embodiments, the receptacle may be of any suitable shape (e.g., triangular, rectangular, etc.) as the disclosure is not so limited.

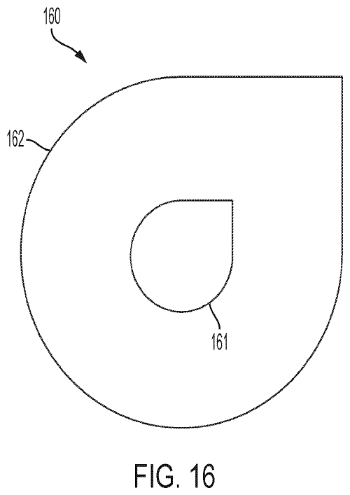

An illustrative embodiment of a beverage tablet that may be used with the beverage machine embodiments disclosed herein is shown in FIG. 16. FIG. 16 depicts a bottom view of a beverage tablet 160 having a teardrop-shaped outer wall 162. The tablet may also have a teardrop-shaped void 161. The void may be a blind hole or a through hole. In the case of a blind hole, the blind hole has an interior surface that rests on top of the post of the beverage machine. This interior surface of the blind hole may be flat, rounded, or cone-like. As discussed in a later section with respect to FIGS. 13A-13C, the post may have a top surface that matches the profile of this interior surface, e.g., may also be flat (e.g. FIG. 13A), cone-like (FIG. 13B), or rounded (e.g. FIG. 13C).

While in the embodiment of FIG. 15A only three supporting ledges 608 are shown, any suitable number of supporting ledges may be included as the disclosure is not so limited. For example, in some embodiments there may be 1, 2, 3, 4, 5, 6, 7, 8, 9, 10, or more supporting ledges 608 arranged around an inner perimeter of the receptacle 612. The supporting ledges may also be spaced from one another by any suitable distance along the perimeter as indicated by the arrows in FIG. 15A. The supporting ledges may be constructed of any suitable materials including, but not limited to metals, plastics, rubbers, etc. Accordingly, the material of the supporting ledges may be selected such that the ledges are rigid or at least partially flexible.

In some embodiments, the shape and/or size of the supporting ledges themselves may be adjusted to facilitate stability and support for a corresponding beverage tablet. For example, any number of the supporting ledges may extend inwardly towards a center of the receptacle 612 at a length of greater than or equal to 1 mm, 1.5 mm, 2 mm, 2.5 mm, 3 mm, 3.5 mm, 4 mm, 4.5 mm, 5 mm, 5.5 mm, 6 mm, 7.5 mm, 8 mm, 8.5 mm, 9 mm, 9.5 mm, 10 mm, 11 mm, 12 mm, 13 mm, 14 mm, 15 mm, or greater. The supporting ledges may also be of any suitable width including, but not limited to greater than or equal to 0.5 mm, 1 mm, 1.5 mm, 2 mm, 3 mm, 4 mm, 5 mm, or greater. The supporting ledges may also be of any suitable height including, but not limited to greater than or equal to 0.5 mm, 1 mm, 1.5 mm, 2 mm, 3 mm, 4 mm, 5 mm, or greater. Combinations of the foregoing are also possible, and ranges both greater and lesser than those noted above are also contemplated.

As disclosed herein, in some embodiments the breakage post may interface with a void of the beverage tablet and may rotate and/or translate to provide breakage to the tablet. In some embodiments, the post that interfaces with the void of the beverage tablet may be stationary, and the chamber itself may rotate and/or translate relative to a stationary post interfaced with a beverage tablet to provide breakage to the tablet.

The inventors have also recognized benefits associated with performing a multitude of the breakage methods above to maximize breakage of the beverage tablet. In some embodiments, the posts of the beverage machine may rotate and/or translate to provide initial breakage to the beverage tablet, and then the chamber lid may also close upon the tablet to provide a compressive force to the tablet, thereby resulting in further breakage of the tablet. Alternatively, the chamber lid may first apply the compressive force, and then the posts may rotate and/or translate to provide further breakage to the tablet. Without wishing to be bound by theory, other combinations of the above breakage methods are also contemplated.

FIG. 15B shows a perspective view of the chamber 602 of FIG. 15A including a plurality of recesses 604 and a plurality of supporting ledges 608. The recesses 604 may be of a sufficient shape and sizing to allow a user to place their fingers in the recesses to grasp the tablet. The recesses may also be sloped to assist a user in placing and/or removing the tablet from the receptacle 612. As can be seen in FIG. 15B, the chamber 602 may include an inner skirt 614 extending downwards from a top of the receptacle 612 towards a base of the chamber 602 at a predetermined distance D1. The inventors have recognized that such an inner skirt may help maintain stability and positioning of a beverage tablet within the receptacle 612, especially for smaller beverage tablets which may have a tendency to tip and fall to the bottom of the receptacle. In some embodiments, instead of the inner skirt extending downwards in the receptacle, the inner skirt may extend upwards and protrude out of the receptacle. In some embodiments, the inner skirt may extend both downwards into the receptacle and upwards out of the receptacle to retain a beverage tablet as the disclosure is not so limited. In some embodiments, a suitable distance D1 may be greater than or equal to 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, or greater.

FIGS. 15C-D show embodiments where differently shaped supporting ledges are used. In FIG. 15C, a substantially rectangular supporting ledge 608 extending inwardly from a sidewall 603 of a chamber 602 is shown. In contrast, FIG. 15D shows a substantially triangular supporting ledge 610 extending inwardly from the chamber 602. While these shapes are disclosed, any suitable shape may be used for the supporting ledges (e.g., diamond-shaped, curved, etc.) as the disclosure is not so limited.

According to one aspect, a beverage machine may be configured to receive beverage tablets of different sizes to form different types of beverages (e.g. beverages with larger volume, with higher concentrations, etc.).

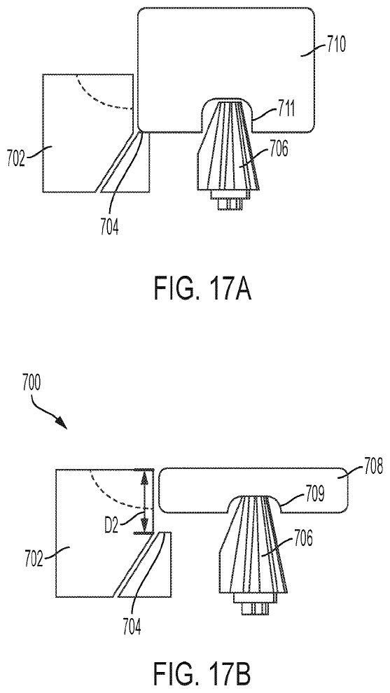

FIGS. 17A-B show partial schematic views of a chamber 702 and breakage post 706 arrangement interacting with beverage tablets of different sizes. In FIG. 17A, the chamber 702 and breakage post 706 arrangement are configured to receive the tablet 710, as the breakage post 706 fits within the blind hole 711 of the tablet 710 and the tablet 710 makes contact with and is supported by the supporting ledge 704. As shown in FIG. 17B, when the same chamber 702 and breakage post 706 arrangement is used with a smaller tablet 708 that is a shorter height than that of the tablet 710 of FIG. 17A, the tablet 708 does not make contact with and is not supported by the supporting ledge 704.

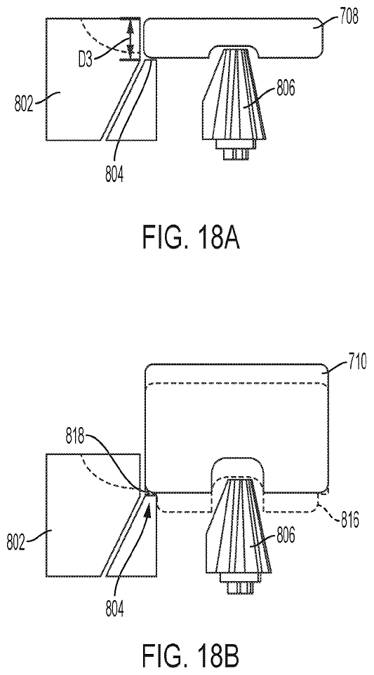

FIGS. 18A-B show partial schematic views of a chamber 802 and breakage post 806 arrangement interacting with beverage tablets of different sizes. In this illustrative embodiment, the depth D3 of the supporting ledge 804 is shorter than the depth D2 of the supporting ledge 704 of the previous embodiment of FIGS. 17A, 17B, such that the smaller tablet 708 with the shorter height is supported by both the breakage post 806 and the supporting ledge 804. However, as seen in FIG. 18B, when this chamber 802 with the shallower supporting ledge 804 receives the larger tablet 710 with the taller height, the tablet does not reach the breakage post 806 due to interference with the shallower supporting ledge 804. As such, in some embodiments, a tablet 816 with an alternative shape (shown in dotted lines) may be used, where the tablet includes an indented flange 818 to conform to the supporting ledge 804. This way, the tablet 816 rests on the supporting ledge 804 via a flange 818 and also rests on the breakage post 806. In such an arrangement, a portion of the tablet may extend below the supporting ledge 804.

In some embodiments, the beverage tablets may contain any suitable mass of beverage ingredient such that they can be received by the chamber. For example, a suitable beverage tablet mass may be greater than or equal to 1 gram, 2 grams, 3 grams, 4 grams, 5 grams, 6 grams, 7 grams, 8 grams, 9 grams, 10 grams, 11 grams, 12 grams, 13 grams, 14 grams, 15 grams, 16 grams, 17 grams, 18 grams, 19 grams, 20 grams, 25 grams, 30 grams, 40 grams, 50 grams, or greater.

### Additional Embodiments

The present disclosure further provide embodiments described in the following numbered paragraphs:
1) A beverage tablet for use in forming a beverage, the tablet comprising:
   a body made of one or more beverage ingredients;
   an outer wall; and
   at least one void extending into the body,
   wherein the at least one void has a shape with a finite order of rotational symmetry.
2) The tablet of paragraph 1), wherein the outer wall has a shape with a finite order of rotational symmetry.
3) The tablet of any one of the above paragraphs, wherein the shape of the at least one void has an order of rotational symmetry of 1.
4) The tablet of any one of the above paragraphs, wherein the at least one void is configured to receive at least one post of a beverage machine.
5) The tablet of paragraph 4), wherein the at least one post is configured to provide breakage of the tablet into a plurality of pieces.
6) The tablet of any one of the above paragraphs, wherein the at least one void is symmetric.
7) The tablet of any one of the above paragraphs, wherein the tablet has only one void.
8) The tablet of any one of paragraphs 1)-6), wherein the at least one void comprises a plurality of voids.
9) The tablet of paragraph 8), wherein the voids of the plurality of voids are equally spaced.
10) The tablet of any one of the above paragraphs, wherein the at least one void is a through-hole that extends completely through the body.
11) The tablet of any one of the above paragraphs, wherein the at least one void is a blind hole that extends only partially through the body.
12) The tablet of any one of the above paragraphs, wherein the outer wall includes an embossed pattern.
13) The tablet of any one of the above paragraphs, wherein the shape of the at least one void is non-circular.
14) The tablet of any one of the above paragraphs, wherein the shape of the outer wall is non-circular.
15) The beverage tablet of any one of the above paragraphs, wherein the outer wall has a teardrop shape.
16) The tablet of any one of the above paragraphs, wherein the outer wall is made of one or more beverage ingredients.
17) The tablet of paragraph 16), wherein at least one beverage ingredient in the body and the outer wall is the same.
18) The tablet of paragraph 16), wherein at least one beverage ingredient in the body is not in the outer wall, and/or at least one beverage ingredient in the outer wall is not in the body.
19) The tablet of paragraph 16), wherein the one or more beverage ingredients of the body comprises coffee.
20) The tablet of paragraph 16), wherein the one or more beverage ingredients of the outer wall comprises coffee.
21) The tablet of any one of the above paragraphs, wherein the at least one void is of a teardrop shape.
22) The tablet of any one of paragraphs 1)-6), wherein the at least one void is of an oval shape.
23) The tablet of any one of paragraphs 1)-5), wherein the at least one void is asymmetric.
24) A beverage tablet for use in forming a beverage, the tablet comprising:
   a body made of one or more beverage ingredients;
   an outer wall; and
   a plurality of voids extending into the body.
25) The tablet of paragraph 24), at least one of the plurality of voids is configured to receive a post of a beverage machine.
26) The tablet of any one of paragraphs 24)-25), wherein the plurality of voids is configured to facilitate breakage of the tablet by a beverage machine.
27) The tablet of any one of paragraphs 24)-26), wherein the outer wall has a shape with a finite order of rotational symmetry.
28) The tablet of any one of paragraphs 24)-26), wherein the outer wall is non-circular.
29) The beverage tablet of paragraph 28), wherein the outer wall has a teardrop shape.
30) The tablet of any one of paragraphs 24)-26), wherein the outer wall is circular.
31) The tablet of any one of paragraphs 24)-29), wherein at least one of the plurality of voids has a finite order of rotational symmetry.
32) The tablet of any one of paragraphs 24)-29), wherein the at least one of the plurality of voids is non-circular.
33) The tablet of any one of paragraphs 24)-29), wherein at least one of the plurality of voids is circular.
34) The tablet of any one of paragraphs 24)-29), wherein at least one of the plurality of voids has an order of rotational symmetry of one.
35) The tablet of any one of paragraphs 24)-34), wherein at least one of the plurality of voids is symmetric.
36) The tablet of any one of paragraphs 24)-35), wherein at least one of the plurality of voids is a through-hole that extends completely through the body.
37) The tablet of any one of paragraphs 24)-35), wherein at least one of the plurality of voids is a blind hole that extends only partially through the body.
38) The tablet of any one of paragraphs 24)-37), wherein the outer wall includes an embossed pattern.
39) The tablet of any one of paragraphs 24)-38), wherein the outer wall is made of one or more beverage ingredients.
40) The tablet of paragraph 39), wherein at least one beverage ingredient in the body and the outer wall is the same.
41) The tablet of paragraph 39), wherein at least one beverage ingredient in the body is not in the outer wall, and/or at least one beverage ingredient in the outer wall is not in the body.
42) The tablet of any one of paragraphs 24)-41), wherein the one or more beverage ingredients of the body comprises coffee.
43) The tablet of paragraph 38), wherein the one or more beverage ingredients of the outer wall comprises coffee.
44) The tablet of any one of paragraphs 24)-43), wherein at least one of the plurality of voids is of a teardrop shape.
45) The tablet of any one of paragraphs 24)-35), wherein at least one of the plurality of voids is of an oval shape.
46) The tablet of any one of paragraphs 24)-34), wherein at least one of the plurality of voids is asymmetric.
47) A beverage machine for forming a beverage comprising:
   a chamber having a receptacle configured to receive a beverage tablet with at least one void in the tablet; and
   at least one post configured to be received within the at least one void of the tablet, wherein the at least one post is configured to provide breakage of the tablet into a plurality of pieces by movement of the at least one post relative to the chamber.
48) The beverage machine of paragraph 47), wherein the chamber further comprises a chamber lid having a closed position and an open position, wherein in the closed position, the chamber lid covers the receptacle, and in the open position, the receptacle is exposed.
49) The beverage machine of paragraph 48), wherein the at least one post is disposed on at least one of the chamber receptacle and the chamber lid.
50) The beverage machine of paragraph 49), wherein the at least one post comprises two posts configured to rotate in opposite directions.
51) The beverage machine of paragraph 49), wherein the at least one post comprises one stationary post and one post that is configured to rotate relative to the stationary post.
52) The beverage machine of paragraph 49), wherein the at least one post comprises two posts configured to rotate in the same direction at different velocities.
53) The beverage machine of paragraph 49), wherein the at least one post comprises two posts configured to rotate in the same direction at the same velocity.
54) The beverage machine of paragraph 49), wherein the at least one post comprises two posts configured to translate in opposite directions.
55) The beverage machine of paragraph 49), wherein the at least one post comprises one stationary post and one post configured to translate relative to the stationary post.
56) The beverage machine of paragraph 49), wherein the at least one post comprises two posts configured to translate in the same direction at different velocities.
57) The beverage machine of paragraph 49), wherein the at least one post comprises two posts configured to translate in the same direction at the same velocity.
58) The beverage machine of paragraph 49), wherein the at least one post comprises only one post, the post being disposed on the receptacle and being configured to rotate.
59) The beverage machine of paragraph 49), wherein the at least one post comprises only one post, the post being disposed on the chamber lid and being configured to rotate.
60) The beverage machine of paragraph 49), wherein the at least one post comprises only one post, the post being disposed on the receptacle and being configured to translate.
61) The beverage machine of paragraph 49), wherein the at least one post comprises only one post, the post being disposed on the chamber lid and being configured to translate.
62) The beverage machine of paragraph 49), wherein the at least one post is of a different shape than the at least one void.
63) The beverage machine of paragraph 48), further comprising at least one hub disposed on at least one of the chamber lid and the receptacle, wherein the at least one post comprises a plurality of posts disposed on the at least one hub.
64) The beverage machine of paragraph 63), wherein the at least one hub is configured to rotate relative to the chamber, and wherein the plurality of posts rotate with the at least one hub.
65) The beverage machine of paragraph 63), wherein the at least one hub comprises two hubs configured to rotate in opposite directions, wherein each hub has a plurality of posts disposed thereon.
66) The beverage machine of paragraph 63), wherein the at least one hub comprises one stationary hub and one hub that is configured to rotate relative to the stationary hub.
67) The beverage machine of paragraph 63), wherein the at least one hub comprises two hubs configured to rotate in the same direction at different velocities.
68) The beverage machine of paragraph 63), wherein the at least one hub comprises two hubs configured to rotate in the same direction at the same velocity.
69) The beverage machine of paragraph 63), wherein the at least one hub comprises two hubs configured to translate in opposite directions.
70) The beverage machine of paragraph 63), wherein the at least one hub comprises one stationary hub and one hub configured to translate relative to the stationary hub.
71) The beverage machine of paragraph 63), wherein the at least one hub comprises two hubs configured to translate in the same direction at different velocities.
72) The beverage machine of paragraph 63), wherein the at least one hub comprises two hubs configured to translate in the same direction at the same velocity.
73) The beverage machine of paragraph 63), wherein the at least one hub comprises only one hub, the hub being disposed on the receptacle and being configured to rotate relative to the receptacle.
74) The beverage machine of paragraph 63), wherein the at least one hub comprises only one hub, the hub being disposed on the chamber lid and being configured to rotate relative to the chamber lid.
75) The beverage machine of paragraph 63), wherein the at least one hub comprises only one hub, the hub being disposed on the receptacle and being configured to translate relative to the chamber lid.
76) The beverage machine of paragraph 63), wherein the at least one hub comprises only one hub, the hub being disposed on the chamber lid and being configured to translate relative to the chamber lid.
77) The beverage machine of paragraph 63), wherein at least one of the plurality of posts is of a different shape than the at least one void.
78) The beverage machine of paragraph 47), wherein the chamber further comprises one or more ribs positioned along a sidewall of an interior of the chamber, and wherein the one or more ribs are configured to facilitate breakage of the beverage tablet.
79) The beverage machine of paragraph 78), wherein the one or more ribs include a plurality of ribs, and wherein the plurality of ribs are positioned at regular intervals along the chamber sidewall.
80) The beverage machine of paragraph 78), wherein the one or more ribs include a plurality of ribs, and wherein the plurality of ribs are positioned at irregular intervals along the chamber sidewall.
81) The beverage machine of paragraph 47), wherein the at least one void comprises a blind hole that extends only partially through a body of the beverage tablet.
82) The beverage machine of any one of paragraphs 47)-81), wherein the at least one post has a teardrop shape.
83) The beverage machine of any one of paragraphs 47)-80), wherein the chamber comprises a brew chamber.
84) The beverage machine of any one of paragraph 47)-80), further comprising a brew chamber, wherein the brew chamber is downstream from the chamber.
85) A beverage forming arrangement comprising:
   a beverage machine; and
   a beverage tablet for forming a beverage, wherein the beverage tablet comprises a body and an outer wall, wherein the body is made of one or more beverage ingredients, and wherein the beverage tablet further comprises at least one void extending into the body,
   wherein the at least one void of the beverage tablet is configured to facilitate breakage of the beverage tablet into a plurality of pieces by the beverage machine.
86) The beverage forming arrangement of paragraph 85), wherein the at least one void of the beverage tablet is configured to receive at least one post of the beverage machine, and wherein the beverage tablet is configured to break into the plurality of pieces in response to movement of the post.
87) The beverage forming arrangement of paragraph 86), wherein the beverage tablet is configured to move with movement of the post.
88) The beverage forming arrangement of paragraph 87), wherein the beverage tablet is configured to rotate with rotation of the post.
89) The beverage forming arrangement of paragraph 86), wherein the at least one void of the beverage tablet is configured to receive a plurality of posts of the beverage machine.
90) The beverage forming arrangement of any one of paragraphs 85)-89), wherein the outer wall has a finite order of rotational symmetry.
91) The beverage forming arrangement of any one of paragraphs 85)-89), wherein the outer wall is non-circular.
92) The beverage forming arrangement of paragraph 91), wherein the outer wall has a teardrop shape.
93) The beverage forming arrangement of any one of paragraphs 85)-89), wherein the outer wall is circular.
94) The beverage forming arrangement of any one of paragraphs 85)-89), wherein the at least one void has a finite order of rotational symmetry.
95) The beverage forming arrangement of any one of paragraphs 85)-89), wherein the at least one void is non-circular.
96) The beverage forming arrangement of any one of paragraphs 85)-89), wherein the at least one void is circular.
97) The beverage forming arrangement of any one of paragraphs 85)-96), wherein the at least one void comprises a plurality of voids.
98) The beverage forming arrangement of any one of paragraphs 85)-96), wherein the at least one void comprises a through-hole that extends completely through the body of the beverage tablet.
99) The beverage forming arrangement of any one of paragraphs 85)-96), wherein the at least one void comprises a blind hole that extends only partially through the body of the beverage tablet.
100) The beverage forming arrangement of any one of paragraphs 85)-99), wherein the outer wall is made of one or more beverage ingredients.
101) The beverage forming arrangement of paragraph 100), wherein at least one beverage ingredient in the body is not in the outer wall, and/or at least one beverage ingredient in the outer wall is not in the body.
102) The beverage forming arrangement of paragraph 100), wherein at least one beverage ingredient in the body and the outer wall is the same.
103) The beverage forming arrangement of any one of paragraphs 85)-102), wherein the one or more beverage ingredients of the body comprises coffee.
104) The beverage forming arrangement of any one of paragraphs 85)-103), wherein the one or more beverage ingredients of the outer wall comprises coffee.
105) The beverage forming arrangement of any one of paragraphs 85)-104), wherein the beverage tablet is configured to be received within the beverage machine without packaging such that the at least one beverage ingredient of the body directly contacts the beverage machine prior to operation.
106) The beverage forming arrangement of any one of paragraphs 85)-105), wherein the beverage machine further comprises:
   a chamber configured to receive the beverage tablet, one or more ribs positioned along a sidewall of an interior of the chamber, and wherein the one or more ribs are configured to facilitate breakage of the beverage tablet.
107) The beverage forming arrangement of paragraph 106), wherein the one or more ribs include a plurality of ribs, and wherein the plurality of ribs are positioned at regular intervals along the chamber sidewall.
108) The beverage forming arrangement of paragraph 106), wherein the one or more ribs include a plurality of ribs, and wherein the plurality of ribs are positioned at irregular intervals along the chamber sidewall.
109) The beverage forming arrangement of paragraph 85), wherein the beverage machine further comprises:
   a chamber configured to receive the beverage tablet, the chamber having a chamber receptacle and a chamber lid;
   at least one post positioned within the chamber receptacle of the beverage machine,
   wherein the at least one post is configured to receive the at least one void of the tablet,
   and wherein the chamber lid of the beverage machine is configured to apply a compressive force to the beverage tablet against the at least one post to provide breakage of the tablet into the plurality of pieces.
110) The beverage forming arrangement of paragraph 109), wherein the at least one post is tapered such that a base of the at least one post is wider than a top of the at least one post.
111) The beverage forming arrangement of paragraph 110), wherein the at least one void is inversely tapered such that a geometry of the at least one void complements a geometry of the at least one post.
112) The beverage forming arrangement of paragraph 109), further comprising one or more cavities formed in the chamber receptacle, wherein the one or more cavities are configured to receive at least a portion of the plurality of tablet pieces.
113) The beverage machine of paragraph 112), wherein the one or more cavities are configured to be closed off by a covering which is movable between a retracted and an extended position.
114) The beverage forming arrangement of paragraph 109), further comprising one or more fins disposed within the chamber receptacle, wherein the one or more fins are configured to facilitate breakage of the tablet into the plurality of pieces.
115) The beverage machine of any one of paragraphs 85)-114), wherein the chamber comprises a brew chamber, and wherein a beverage is configured to be brewed in the brew chamber.
116) The beverage machine of any one of paragraphs 85)-114), further comprising a brew chamber, wherein the brew chamber is downstream of the chamber.
117) The beverage forming arrangement of any one of paragraphs 85)-116), wherein at least one of the plurality of voids is of a teardrop shape.
118) The beverage forming arrangement of any one of paragraphs 85)-116), wherein at least one of the plurality of voids of the beverage tablet is of an oval shape.
119) The beverage forming arrangement of any one of paragraphs 85)-116), wherein at least one of the plurality of voids of the beverage tablet is asymmetric.
120) A beverage machine for forming a beverage comprising:
   a chamber having a chamber receptacle configured to receive a beverage tablet, the tablet having at least one void; and
   at least one post positioned within the chamber receptacle and configured to be received in the at least one void of the beverage tablet, wherein the at least one post is configured to support the beverage tablet as a compressive force is applied to the beverage tablet by the beverage machine to provide breakage of the beverage tablet into a plurality of pieces.
121) The beverage machine of paragraph 120), further comprising a chamber lid, wherein closure of the chamber lid causes a bottom surface of the chamber lid to apply the compressive force to the beverage tablet.
122) The beverage machine of paragraph 121), wherein the chamber lid has a closed position and an open position, wherein in the closed position, the chamber lid covers the chamber receptacle, and in the open position, the chamber receptacle is exposed.
123) The beverage machine of paragraph 120), wherein the at least one post is tapered such that a base of the at least one post is wider than a top of the at least one post.
124) The beverage machine of paragraph 123), wherein the at least one void is inversely tapered such that a geometry of the at least one void complements a geometry of the at least one post.
125) The beverage machine of paragraph 120), further comprising one or more cavities formed in the chamber receptacle, wherein the one or more cavities are configured to receive at least a portion of the plurality of tablet pieces.
126) The beverage machine of paragraph 125), wherein the one or more cavities are configured to be closed off by a covering which is movable between a retracted and an extended position.
127) The beverage machine of paragraph 120), further comprising one or more fins attached to the at least one post, wherein the one or more fins are configured to facilitate breakage of the tablet into the plurality of pieces.
128) The beverage machine of paragraph 120), wherein the at least one post is stationary relative to the chamber.
129) The beverage machine of paragraph 120), wherein the at least one post is moveable relative to the chamber.
130) The beverage machine of paragraph 129), wherein the at least one post is rotatable relative to the chamber, wherein rotation of the at least one post is configured to further break the plurality of pieces into smaller pieces.
131) The beverage machine of paragraph 130), wherein the at least one post further comprises a plurality of blades extending outwardly from a center of the at least one post.
132) The beverage machine of paragraph 131), wherein the chamber receptacle comprises a sidewall, and wherein a plurality of ribs protrude from the sidewall, wherein the rotation of the at least one post is configured to break the plurality of pieces between the blades of the post and the ribs of the chamber receptacle sidewall.
133) The beverage machine of paragraph 120), further comprising at least one supporting ledge configured to contact and support an outer portion of the beverage tablet as the compressive force is applied to the beverage tablet.
134) The beverage machine of paragraph 120), wherein the at least one post has a teardrop shape.
135) The beverage machine of any one of paragraphs 120)-131), wherein the chamber comprises a brew chamber, and wherein a beverage is configured to be brewed in the brew chamber.
136) The beverage machine of any one of paragraphs 120)-131), further comprising a brew chamber, wherein the brew chamber is downstream of the chamber.
137) A method of forming a beverage from a beverage tablet, the method comprising:
   receiving a beverage tablet within a chamber of a beverage machine;
   applying a compressive force to the beverage tablet to break the tablet into a plurality of pieces; and
   introducing a beverage precursor liquid to form a beverage.
138) The method of paragraph 137), wherein receiving the beverage tablet within the chamber comprises receiving a post of the beverage machine is within a void of the beverage tablet, and wherein the post supports the beverage tablet as the compressive force is applied to the tablet.
139) The method of paragraph 137), wherein the step of applying a compressive force to the beverage tablet comprises closing a chamber lid, wherein a surface of the chamber lid contacts and applies the compressive force to the beverage tablet.
140) The method of paragraph 137), wherein the compressive force is applied to the beverage tablet by a piston of the beverage machine.
141) The method of paragraph 138), further comprising rotating the post relative to the chamber to break the plurality of pieces into smaller pieces.

The embodiments disclosed herein may be combined in any suitable arrangement as the disclosure is not limited in this regard. While the present teachings have been described in conjunction with various embodiments and examples, it is not intended that the present teachings be limited to such embodiments or examples. On the contrary, the present teachings encompass various alternatives, modifications, or equivalents, as will be appreciated by those of skill in the art. Accordingly, the foregoing description is by way of example only.

1. A beverage tablet for use in forming a beverage, the tablet comprising:
a body made of one or more beverage ingredients;
an outer wall; and
at least one void extending into the body,
wherein the at least one void has a shape with a finite order of rotational symmetry.

2. The tablet of claim 1, wherein the outer wall has a shape with a finite order of rotational symmetry.

3. The tablet of claim 1, wherein the shape of the at least one void has an order of rotational symmetry of 1.

4. The tablet of claim 1, wherein the at least one void is configured to receive at least one post of a beverage machine.

5. The tablet of claim 4, wherein the at least one post is configured to provide breakage of the tablet into a plurality of pieces.

6. The tablet of claim 1, wherein the at least one void is symmetric.

7. The tablet of claim 1, wherein the tablet has only one void.

8. The tablet of claim 1, wherein the at least one void comprises a plurality of voids.

9. The tablet of claim 8, wherein the voids of the plurality of voids are equally spaced.

10. The tablet of claim 1, wherein the at least one void is a through-hole that extends completely through the body.

11. The tablet of claim 1, wherein the at least one void is a blind hole that extends only partially through the body.

12. The tablet of claim 1, further comprising a coating covering at least a portion of the body.

13. The tablet of claim 1, wherein the shape of the at least one void is non-circular.

14. The tablet of claim 1, wherein the shape of the outer wall is non-circular.

15. The beverage tablet of claim 1, wherein the outer wall has a teardrop shape.

16. The tablet of claim 1, wherein the outer wall is made of one or more beverage ingredients.

17. The tablet of claim 16, wherein at least one beverage ingredient in the body and the outer wall is the same.

18. The tablet of claim 16, wherein at least one beverage ingredient in the body is not in the outer wall, and/or at least one beverage ingredient in the outer wall is not in the body.

19. The tablet of claim 16, wherein the one or more beverage ingredients of the body comprises coffee.

20. The tablet of claim 16, wherein the one or more beverage ingredients of the outer wall comprises coffee.

21. The tablet of claim 1, wherein the at least one void is of a teardrop shape.

22. The tablet of claim 1, wherein the at least one void is of an oval shape.

23. The tablet of claim 1, wherein the at least one void is asymmetric.

24. A beverage tablet for use in forming a beverage, the tablet comprising:
a body made of one or more beverage ingredients;
an outer wall; and
a plurality of voids extending into the body.

25-58. (canceled)

59. A method of forming a beverage from a beverage tablet, the method comprising:
receiving a beverage tablet within a chamber of a beverage machine;
applying a compressive force to the beverage tablet to break the tablet into a plurality of pieces; and
introducing a beverage precursor liquid to form a beverage.

60-63. (canceled)
